(19) United States
(12) Patent Application Publication
(10) Pub. No.: US 2017/0306187 A1
(43) Pub. Date: Oct. 26, 2017

(54) MODIFIED PHYLLOSILICATES FOR CONTROLLING THE UNWINDING FORCE OF PRESSURE-SENSITIVE ADHESIVE MATERIALS AND IMPROVING THE BARRIER PROPERTIES OF ADHESIVE TAPES

(71) Applicant: TESA SE, Norderstedt (DE)

(72) Inventors: Nicolai BÖHM, Hamburg (DE); Michael MIES, Hamburg (DE); Dennis SEITZER, Eningen unter Achalm (DE); Daniel WIENKE, Hamburg (DE)

(73) Assignee: TESA SE, Norderstedt (DE)

(21) Appl. No.: 15/526,119

(22) PCT Filed: Oct. 29, 2015
(86) PCT No.: PCT/EP2015/075087

§ 371 Date: May 11, 2017

(30) Foreign Application Priority Data
Nov. 18, 2014 (DE) 10 2014 223 451.4

(51) Int. Cl. C09J 7/04; C09J 11/04; C08K 3/34; C09J 133/20; B60R 16/02

(52) U.S. Cl. CPC C09J 7/045; C09J 11/04; C09J 2400/263; C09J 2205/102; C09J 2203/302; C09J 2201/606; B60R 16/0215; C09J 2201/122; C09J 133/20; C08K 3/34; C09J 2433/00; C09J 2201/602

(57) ABSTRACT

Pressure-sensitive adhesive material comprising an acrylate dispersion wherein the acrylate dispersion comprises (i) an aqueous acrylate polymer dispersion containing polymers composed of a) acrylate monomers and, optionally, b) ethylenically unsaturated comonomers that are not acrylates, and (ii) modified phylosilicates

This is a 371 of PCT/EP2015/075087 filed 29 Oct. 2015, which claims foreign priority benefit under 35 U.S.C. 119 of German Patent Application 10 2014 223 451.4 filed Nov. 18, 2014, the entire contents of which are incorporated herein by reference.

The invention pertains to a pressure-sensitive adhesive (PSA). Likewise a subject of the invention are adhesive tapes for jacketing elongate material such as, in particular, cable looms in automobiles its production and the use for jacketing cables, where the adhesive tape of the invention has a carrier and a pressure-sensitive adhesive of the invention applied on at least one side of the carrier.

### BACKGROUND OF THE INVENTION

Adhesive tapes have long been used in industry for producing cable harnesses. The adhesive tapes in that case serve for the bundling of a multiplicity of electrical leads before installation or when already mounted, in order to reduce the space taken up by the bundle of leads, by means of bandaging, and also, in addition, to obtain protective functions.

The testing and classifying of adhesive tapes for cable jacketing takes place in the automobile industry in accordance with extensive sets of standards such as, for example, LV 312-1 “Protection Systems for Wire Harnesses in Motor Vehicles, Adhesive Tapes; Test Guideline” (10/2009) as a joint standard of the companies Daimler, Audi, BMW, and Volkswagen, or the Ford specification ES-XU5T-1A303-aa (revised version 09/2009) “Harness Tape Performance Specification”. In the text below, these standards are referred to for short as LV 312 and as Ford specification, respectively.

Cable wrapping tapes with film and textile carriers are widespread, being generally coated on one side with various PSAs. These cable wrapping tapes are required to meet four primary requirements:
a. Ease of unwind:
   For simple processing, the product dispensed in roll form must be easily unwindable, adhesive tape wound around a body—meaning the tendency of one end of the adhesive tape to stand up. The cause is the combination of the adhesive's holding power, the stiffness of the carrier, and the diameter of the cable loom. The bond/bandaging, which under no circumstances may come apart again, is subject to extremely exacting requirements of a balanced relationship between cohesive and adhesive, since in practice ends of adhesive tape must not spontaneously detach.
b. Cable compatibility:
   The cable insulation must not become brittle as a result of the influence of the adhesive tape in combination with elevated temperature over a prolonged time period. A distinction is made here, in accordance with LV 312, between four temperature classes T1 to T4, corresponding to 80° C. (also called temperature class A), 105° C. (also called temperature class B (105)), 125° C. (also called temperature class C), and 150° C. (also called temperature class D), which the wrapped cables are required to withstand without embrittlement for more than 3000 h. It is obvious that temperature classes T3 and T4 impose more stringent requirements on the adhesive tape than do the lower classes T1 and T2. The T1 to T4 classification is decided not only by the cable insulation material but also by PSA and type of carrier.
c. Chemical compatibility, or compatible with media in the engine compartment
d. Uneven, nonuniform substrates as a result of the cable runs, convoluted tubes, and branches. Other factors are flexural and tensile stresses in the case of production, installation, and subsequent use within the engine compartment of an automobile, or else in the vehicle body, with continual flexural stress during opening of doors.

Since the end of the adhesive tape is ideally bonded to its own reverse face, there must be good instantaneous peel adhesion (tack) to this substrate, so that flagging of the adhesive tape does not occur at the start. In order to ensure a flagging-free product durably, the anchoring on the substrate and the internal strength of the adhesive must both be such that the adhesive bond is robust even under the effect of tension (tensile and flexural stressing).

The flagging resistance of WH cable wrapping tapes is demonstrated by way of the TFT method (Threshold Flagging Time).

The realization of easy-unwind WH adhesive tapes in conjunction with retention of good technical adhesive properties poses a major challenge, since the two properties appear to be mutually exclusive: the key criteria for single-side bonding cable wrapping tapes, with adapted unwind force and sufficiently high peel adhesion, are in flat contradiction with one another. Whereas good flow-on behavior and anchoring behavior on the part of the PSA are prerequisites for good peel adhesion values and an associated low flagging potential, these criteria are more of a hindrance to convenient unwind performance.

Given the fact that for textile carrier materials reduction of the unwind force is barely possible to achieve technically by means of release agents, and entails high costs anyway, the plies of adhesive tape are wrapped directly onto one another, with the adhesive bonding to the reverse face of each tape ply beneath. To ensure unwind without residues of adhesive on the reverse face of the carrier, the requirements for a balanced relationship between cohesive and adhesive are extremely exacting.

For example, cable wrapping tapes with PSAs based on natural rubber usually have good flagging resistance, but exhibit an unwind force which increases over the storage period and also under increasing temperatures. Such tapes, moreover, meet only the lower temperature classes for cable compatibility. WO 2006/015816 A1 discloses PSAs based on synthetic rubber with photoinitiators. EP 1 431 360 A2 discloses adhesive tapes which can be wrapped onto themselves and comprise a thermally consolidated nonwoven having a basis weight of 10 to 50 g/m² and UV-crosslinked acrylate adhesive. Also known are fabric adhesive tapes which are based on a crosslinked acrylate hotmelt adhesive, usually on straight acrylate, and are classified in temperature class D (150° C.) according to LV 312. They feature low adhesive anchoring and result in transfer of adhesive from smooth carrier surfaces. Fabric adhesive tapes which are based on an acrylate dispersion adhesive and are classified according to LV 312 in temperature class D (150° C.) are also known. Likewise known are nonwoven-backed adhesive tapes which are based on a crosslinked acrylate hotmelt adhesive, usually straight acrylate, and are classed under LV 312 in temperature class C (125° C.). All of the woven-fabric products possess the same adhesive, which is adjusted to the particular requirements via coatweight and UV crosslinking. A disadvantage of their application on the cable loom are the markedly upstanding tape ends, when these adhesive tapes of the standard range are affixed to critical burns such as branched diversions, transitions, small diameter, etc. While it is possible to control their level of unwind force effectively, by means of the selected coatweight and especially UV crosslinking, to do so entails the unwanted side effects of significantly decreasing peel adhesions and an incalculable flagging risk. Moreover, acrylate hotmelt adhesives can be blended only under complicated conditions, for incorporation of resins or fillers. Against the background of a cost saving, the use of fillers in adhesive design is known. A known example from the sphere of the phyllosilicates here are kaolins, which are two-layer silicates. On account of their high layer charge, they are not swellable and therefore take the form of relatively coarse filler particles within the adhesive.

When common fillers such as chalk or kaolin are used, there are significant reductions in the peel adhesion performance. Moreover, the relatively coarse structure of the filler particles always leads to hazing/coloring of the adhesive, which may be undesirable on visual (and in some cases also technical) grounds.

Another disadvantage is that acrylate hotmelt products (such as acResin A260 UV) for producing unwindable products have to be irradiated at least with a 20 mJ/cm³ UV dose, whereas the optimum in technical adhesive terms is obtained at 10 mJ/cm³ UV dose. Conversely, however, in that case, below a UV dose of 20 mJ/cm³, the products exhibit excessive side-edge stickiness on the roll. On packaging, therefore, these rolls have to be separated from one another by interleaves. Another disadvantage is that there is only a small operating window in which the flagging behavior and the flow-on are sufficient on account of the low level of crosslinking; because of the low level of crosslinking, however, cohesional fractures are likely with relatively short polymer chains in the case of acResin products with low molecular weight. Additional crosslinking is therefore necessary in order to ensure adequate cohesion. Under stresses such as tensile or flexural loading, the adhesive easily breaks and the tape ends lift up. Likewise, the relatively weak anchoring of adhesive in the case of hotmelt coating with a smooth carrier surface may result in transfer of adhesive to the reverse face of the carrier.

Also known, moreover, are woven- and nonwoven-backed adhesive tapes which are based on a solvent-borne rubber adhesive and are classed under LV 312 into temperature class B (105° C.). The majority of high-temperature applications (C and D), as already observed, employ straight acrylate hotmelt adhesives—as a general rule, from the acResin range (BASF) which are adapted to particular requirements via coatweight and UV crosslinking. Although these acrylate adhesives do exhibit sufficient temperature stability, they frequently fail on PVC leads which serve as a substrate as part of the specification tests in relation to aging resistance for temperature class B (105° C.).

In order to optimize the technical adhesive properties of (acrylate) adhesives, it is common to add what are called tackifiers in the form of resins, rosin esters for example, which by virtue of their limited temperature stability reinforce the radical breakdown both of the adhesive tape and of the cable insulation. Depending on the affinity of the plasticizer in the cable insulation for the tackifier resin, migration of the plasticizer or plasticizers from the cable insulation into the adhesive of the adhesive tape is accelerated (in this regard, see test results, table 2).

Acrylate adhesives generally have a very high affinity for the usual PVC plasticizers, resulting in a strong tendency toward migration of the so-called monomer plasticizers such as DINP, DIDP or TOTM, for example. It is also known that when PVC-insulated cable leads are used, there is severe plasticizer migration over time, and especially under temperature loading, up to the point where an equilibrium is established between insulation and adhesive tape or adhesive. The result is an unwanted embrittlement of the cable wrapping/cable insulation. In combination with aging effects (oxidation, loss of plasticizer to the environment, breakdown, mechanical loading, etc.), increased plasticizer migration results in premature failure of the cable insulation through embrittlement. For plasticized PVC, this is also known as the “brittle gap”.

For the purposes of reducing or preventing plasticizer migration there are primarily two known measures: thus a) the equilibrium may be made the focus, with plasticizer being added to the adhesive during the actual production process. This, however, leads frequently to far-reaching changes in the technical adhesive properties, up to the point of complete cohesive failure of the adhesive. Alternatively, b) in order to erect an effective barrier, close-mesh crosslinking of the adhesive can be undertaken, again possibly with dramatic consequences for the technical adhesive aspects, however, or finely disperse fillers can be used which are capable of constructing a network.

The objects of the present invention are to provide a pressure-sensitive adhesive and an adhesive tape for which the unwind forces are adjustable over a relatively broad spectrum. Furthermore, the pressure-sensitive adhesive and the adhesive tape are to possess good instantaneous peel adhesion. The adhesive tape is to permit flagging-free bonding in the long term, the intention at the same time being that the pressure-sensitive adhesive should be prevented from flowing too greatly onto rough substrates such as woven-fabric or nonwoven backings of carriers, let alone penetrating these substrates. It is an object of the invention, therefore, that easy unwindability should be obtained in conjunction with high flagging resistance and good instantaneous peel adhesion. Moreover, the adhesive tapes are to be readily adjustable to individual requirements such as particular temperature circumstances, high humidity and/or particular mechanical stresses such as narrow radii or else continual flexing. The adhesive tape is to permit particularly simple, inexpensive, and rapid jacketing of elongate material such as cable looms in automobiles. A preferred aim is for good cable compatibility over all stated temperature classes. A further object is to develop a pressure-sensitive adhesive for these requirements which in particular is applied to carriers and which leads accordingly to adhesive tapes having the stated properties.

A further object of the present invention is to realize high-temperature-resistant acrylate adhesives for applications in the cable bandaging sector (Wire Harnessing applications (WH)) that exhibit excellent compatibility with all common cable insulation, especially that according to the reference spectrum of cables in LV 312.

These objects are achieved by a pressure-sensitive adhesive of the invention, as recorded in the main claim, and also by an adhesive tape of the invention. The dependent claims relate to advantageous developments of the pressure-sensitive adhesive of the invention and of the adhesive tape of the invention, and to methods for employing the adhesive tape.

The adhesive is a pressure-sensitive adhesive (PSA), this being an adhesive which even under relatively weak applied pressure permits durable bonding to virtually all substrates and which, after service, can be detached from the substrate again substantially without residue. At room temperature, a PSA has a permanent pressure-sensitive adhesive effect—that is, it exhibits sufficiently low viscosity and high initial tack, and so it wets the surface of the respective substrate under just low applied pressure. The bondability of the adhesive derives from its adhesive properties, and the redetachability from its cohesive properties.

The PSAs of the invention are based on a base PSA (without added modified phyllosilicates). The focus here is in particular on the assurance of durably flagging-free products in the WH application segment. These PSAs therefore have adhesive designs which are notable for extremely good instantaneous peel adhesion coupled with good anchoring strength on the reverse face of the carrier. Through the relatively long molecular chains (high molecular weight) of the dispersions of the acrylate adhesives, a bond is ensured which retains its integrity even under the effect of stresses (tensile and flexural stressing). Accordingly, such PSAs tend to have a somewhat tougher behavior when removed from the reverse face than is the case, for example, for known hotmelt systems (see acResin), which have significantly lower molecular weights. As a further advantage, the PSAs of the invention on the adhesive tapes exhibit good barrier properties with respect to migration of plasticizers from sheathed cable insulation, which can be effectively prevented.

In order to expand the spectrum of the unwind forces that can be set, it is necessary to perform a balancing act, where the adhesive is hindered from flowing too strongly onto rough substrates (for example woven or nonwoven backings) or, indeed, penetrating such substrates, and where the technical adhesive advantages such as instantaneous peel adhesion and durable, flagging-free bonding are very largely retained. The production of roll product in the desired unwind-force range can be influenced via the winding tension during converting/slitting, such as during log-roll winding, for example, followed by piercing or direct slitting and winding. A key external influencing variable after the production of the roll product is the ambient temperature at which the rolls are stored.

The aforementioned objects are achieved in that PSAs comprising pure or resin-blended acrylate dispersions, more particularly aqueous acrylate dispersions, can be adapted, by defined blending individually with modified phyllosilicates, to the particular requirements of the subsequent application and to the carrier material used. As a result of the modified phyllosilicates used, especially three-layer silicates surface-modified with polar organic compounds, and more preferably organically modified synthetic three-layer silicates, where the surface modification takes place preferably by means of polar interactions or ionic bonds, physical crosslinking sites are created within the PSA by this use of finely disperse fillers, more particularly by means of organically modified phyllosilicates having exceptionally good swellability in water and other polar media.

These phyllosilicates can be exfoliated by moderate shearing forces. The three-dimensional crosslinking thus produced of the polymers or polymer chains of the acrylate dispersion, via the points of attachment on the filler, are reversible, meaning that the PSA retains high attachment capability, but does not attach too strongly to rough substrates. The modified phyllosilicates are preferably surface-modified not via covalent bonds, but instead via intermolecular interactions.

The organic modification is understood accordingly as an interaction between organic molecules such as surfactants and protective colloids, for example, and the surface charge of the bentonites. The interaction is generally in the form of polar and/or ionic interactions. Covalent bonds are generally not formed. It is therefore possible to realize all viscosities steplessly, up to and including a sag-resistant gel.

In contrast to the swellable smectites, kaolins, which are likewise phyllosilicates, are not swellable, because the layers do not move apart, on account of the high layer charge. Smectites are swellable and can be exfoliated by moderate shearing forces, i.e., can be broken down into the individual layers. The three-layer structure of the three-layer silicates consists of a central layer of coordinated-cation octahedra which are surrounded in sandwich format by two layers of [(Si, Al)O₄] tetrahedra. Examples of three-layer silicates are montmorillonites. In their octahedron layer there are numerous substitutions. For instance, besides the predominant aluminum ions (Al³⁺) in montmorillonite, Mg²⁺ in saponite, and Fe³⁺ in nontronite, there may also be cations such as Zn²⁺ in sauconite, Ni²⁺ in nickel S, and Li⁺in hectorite. In the tetrahedron layer, silicon may in part also be replaced by aluminum (Al³⁺) as in the case of beidellite or in the case of montmorillonite, and also by Fe³⁺ as in the case of nontronite. The resulting disequilibria in the charge balance are generally replaced by sodium, calcium, potassium or else magnesium ions between the individual layers.

Suitable phyllosilicates are naturally occurring clay minerals from the smectite group with three-layer structure, an example being bentonite, whose principal component is montmorillonite. The diameter of the individual platelets in the naturally occurring clay minerals here is about 500 to 1000 nm, height about 1 nm, and so it is not possible to produce transparent films of the PSAs. The situation is different for the synthetic phyllosilicates such as hectorites; they contain lithium and generally have platelet diameters in the range from 25 to 50 nm with a height of about 1 nm. With synthetic phyllosilicates, therefore, optical transparent films can be produced. Three-layer silicates which can be used in accordance with the invention are, in particular, colloidal and surface-modified, being surface-modified more particularly with surfactants and/or protective colloids. Laptonites are colloidal, synthetic phyllosilicates (hectorites, with lithium) whose platelet diameter is between 20 to 30 nm, preferably around 25 nm, and whose thickness is around 1 nm. Owing to the small size of the platelets, there can be very rapid reconstruction of the house-of-cards structure, where the edges of one platelet bear in each case on the surface of an adjacent phyllosilicate platelet. The three-layer silicates can be easily stirred into water to form a clear, colorless dispersion. They may form a gel (high-viscosity colloidal dispersion) or a sol (low-viscosity colloidal dispersion).

The sol types comprise a dispersant such as, for example, an amount of tetrasodium pyrophosphate or of phosphonates, more particularly approximately greater than or equal to 5 more particularly approximately greater than or equal to 6 wt %. The dispersant blocks the positively charged edges and therefore blocks the formation of the house-of-cards structure. The blocking can be eliminated by adding polymer particles or filler particles, since the polyanions are absorbed preferentially. Depending on the amount of polymer or filler particles used, sols with low viscosity can be produced, more particularly at an amount of 10 to 40 wt %, preferably around 30 wt %, of polymer or filler particles. In general a distinction may be made between two different types of sol, the temporary and the permanent sol types. For the thickening effect, the release of the blocking agent is critical. Depending on application, a polymer or a filler may be chosen. The filler may be advantageous in that case since, as a better receptor, it can be added at a lower level of addition.

A further subject of the invention is an adhesive tape, especially for wrapping cables, comprising a preferably textile carrier and a pressure-sensitive adhesive which is applied on at least one side of the carrier and which comprises (i) a dried polymeric acrylate dispersion, more particularly an aqueous acrylate dispersion, preferably having a gel value of greater than or equal to 40%, determined by Soxhlet extraction, the polymeric acrylate dispersion comprising polymers which are constructed of a) monomeric acrylates and optionally b) ethylenically unsaturated comonomers which are not acrylates, and (ii) modified phyllosilicates.

The acrylate dispersion preferably has a gel value of greater than or equal to 45%.

Furthermore, the dried polymeric acrylate dispersion in the PSA is formed from an aqueous acrylate dispersion.

Aqueous acrylate dispersions, in other words a polyacrylic ester in fine dispersion in water and having pressure-sensitive adhesive properties, are described in, for example, the Handbook of Pressure Sensitive Technology by D. Satas.

In one preferred embodiment the PSA comprises between 15 and 100 parts by weight of a tackifier (based on the mass of the dried polymeric dispersion).

PSAs of the invention with a total composition of 100 wt % comprise modified phyllosilicates, more particularly modified three-layer silicates, preferably phyllosilicates modified with surfactants and/or protective colloids. Particularly preferred according to one alternative are the synthetic three-layer silicates, in which case the PSAs (based on the mass of the dried polymeric acrylate dispersion, i.e., ad 100 wt %) comprise 0.01 to 6.0 wt % of phyllosilicates, alternatively 0.01 to 5.0 wt %, more particularly 0.01 to 3.5 wt % of phyllosilicates (based on the mass of the phyllosilicates or based on the solids content of the phyllosilicates in dispersions), preference being given to 0.01 to 3.5 wt %, more particularly 0.01 to 3.2 wt %, preferably 0.5 to 2.8 wt %, more preferably 0.5 to 2.0 wt %.

Alternative PSAs of the invention with the total composition of 100 wt % comprise modified phyllosilicates, in which case a dispersion of the phyllosilicates is added at 0.01 to 10.0 wt %, more particularly at 0.01 to 7 wt %, based on the aqueous polymeric acrylate dispersion ad 100 wt %. The acrylate dispersion here may have a solids content of 50 to 60 wt %, based on the aqueous acrylate dispersion. The dispersions of the phyllosilicates may have a phyllosilicates content of 20 to 50 wt %, and preferably have a phyllosilicates content of 42 to 46 wt %.

Another subject of the invention are optically transparent films of PSAs comprising synthetic phyllosilicates.

The modified phyllosilicates used in the PSA are natural or synthetically produced three-layer phyllosilicates. Preference is given to swellable modified phyllosilicates, the modified phyllosilicates being swellable more particularly in polar media such as polar solvents and/or water. Preferred modified phyllosilicates are surface-modified, the modified phyllosilicates being more particularly surface-modified with organic compounds, very preferably with polar organic compounds, where the surface modification takes place substantially via polar and/or ionic interactions. The modified phyllosilicates may be used in the form of powder, paste or else dispersion.

A further subject of the invention is an adhesive tape and also the PSA comprising modified phyllosilicates with a surface area of 50 m²/g to 900 m²/g, preferably of 100 to 600 m²/g, more particularly around 300 m²/g. The surface area of the particles, and whether they are present in the form of primary particles, in other words unagglomerated or unaggregated, can be determined by means of BET analysis (determined according to DIN/ISO/9277: 2003-05 (BET method)). Likewise a subject of the invention is an adhesive tape and also a PSA comprising modified phyllosilicates having a phyllosilicate diameter of 10 to 1000 nm for a height of about 1 nm, where in an alternative a) preferred diameters are from 500 to 1000 nm, more preferably from 500 nm to 700 nm, and in a second alternative b) preferred diameters are from 25 to 50 nm, the height of the phyllosilicates in each case being 100 Angstroms to 5 nm, the height of the phyllosilicates being preferably 0.5 to 2 nm, more preferably around 1 nm. Modified phyllosilicates which can be selected in this context are the following, individually or in any desired mixture: montmorillonite, nontronite, hectorite, saponite, sauconite, beidellite, allevardite, illite, halloysite, attapulgite and/or sepiolite, and also disteardimonium, smectites and/or bentonite.

On the basis of the modified three-layer silicates added it is possible to alter the electrical properties of the PSA and hence also of the adhesive tape. Thus the PSAs of the invention are electrically conductive and/or antistatic; in particular, the PSA is an electrically conductive and/or antistatic coating, preferably on a carrier for forming an electrically conductive adhesive tape.

Optionally, moreover, the PSA may have been electron beam (EBC)-crosslinked.

The advantages of the PSAs of the invention and of the adhesive tape of the invention comprising the aforementioned acrylate dispersions, relative to the stated acrylate hotmelt adhesives, lie essentially in the much higher molecular weights, allowing the production of PSAs combining good attachment behavior (no three-dimensional network through covalent bonds) with sufficient cohesion, so that there is no absolute need for any additional crosslinking step.

A further advantage of the PSAs of the invention is manifested on application of the dispersions, something which is possible with any other wide variety of coating assemblies such as coating knife, comma bar, air knife, roller, Meyer bar, nozzle, etc. This is made possible by virtue of the wide spectrum of PSA viscosities that can be set.

The PSAs of the invention preferably have a high resting viscosity of greater than or equal to 200 Pa*s (at 0.1 s⁻¹), more particularly greater than or equal to 400 Pa*s, preferably greater than or equal to 500 to greater than or equal to 1000 Pa*s (at 0.1 s⁻¹). As a further advantage it may likewise be stated that the anchoring of the PSA or of the dispersion compositions to the majority of substrates is very good, because the composition is applied in liquid form and is therefore able to wet the substrate very effectively. The side-edge stickiness of the adhesive tapes in rolls is acceptable, even in the uncrosslinked state. The aqueous acrylate dispersions may also very easily be blended with predispersed resins, fillers, aging inhibitors, etc.

### SUMMARY OF THE INVENTION

Surprisingly it has been found that through the addition of phyllosilicates to the PSAs, more particularly organically modified, synthetic phyllosilicates, preferably ultrafinely disperse modified phyllosilicates, the unwind force of cable wrapping tapes can be adjusted almost ad infinitum. In contrast to common fillers such as kaolin, the instantaneous peel adhesion is almost completely retained when finely disperse phyllosilicates are added.

Particular advantages of the modified phyllosilicates used in accordance with the invention in aqueous acrylate dispersions are the extremely simple blending of the acrylate dispersions with predispersed phyllosilicates. Through the addition of the phyllosilicates, particularly of the organically modified, synthetic phyllosilicates, it is possible to adjust the unwind force of cable wrapping tapes virtually ad infinitum, and, in contrast to common fillers, the instantaneous peel adhesion is retained almost completely when finely disperse phyllosilicates are added. Furthermore, the finely disperse phyllosilicates may also be used for producing electrically conductive, antistatic coatings. This field of application is of particular interest for electrically conductive adhesive tape applications (electromagnetic shielding).

In contrast to the aforementioned hotmelt adhesives and in contradistinction to other acrylate dispersions, where high quantities of common fillers such as kaolin are added, the systems of the invention also afford high resistance toward flagging.

An advantage of the PSAs of the invention comprising dried polymeric acrylate dispersions, especially the formerly aqueous acrylate dispersions, and also of the adhesive tapes having a PSA on at least one side of the carrier, is the formation of a phyllosilicate network which is able to act as a close-mesh barrier layer (see FIG. 9). It is assumed that the specific surface area of around 900 m²/g and also the crystal morphology (see FIGS. 9 and 10) support this effect. The barrier layer effect can be demonstrated for the diffusion of plasticizers from PVC cable insulation.

Another subject of the invention, therefore, is the use of modified phyllosilicates for forming a close-mesh barrier layer.

Depending on the amount of modified phyllosilicates added to the PSA, plasticizer migration may therefore be slowed down or virtually prevented, and the slipping of the plasticizer content in the PVC, especially in PVC cable insulation, into the “brittle gap” range can be prevented.

To slow down the radical breakdown, preference is given to adding a defined amount of an aging inhibitor such as an antioxidant to the PSA. To adjust the peel adhesion, tackifier resins as elucidated above or below are added to the PSA.

In order to document the slowing of the aging process, it is possible to verify the color or the color stability of the cable insulation (FIGS. 12 and 13). Using modified phyllosilicates such as Laponite SL25 as barrier layer, the cable coloring remains perceptible for longer (see FIG. 13), and this may be rated as a safety aspect and additionally, in the case of repairs, represents a significant working aid. In FIG. 12, the gray coloration of the cable insulation is clearly apparent. In FIG. 13, the original yellow or pale color of the cable insulation, respectively, is still readily perceptible.

Plasticizers are added to plastics such as cable jacketing or cable sheathing in order to render them durably flexible, conforming, and elastic. Plasticizers may be low-volatility resins, esters or oils.

The function of the plasticizers is to shift the thermoplastic range to lower temperatures. Examples of known plasticizers include DINP, DIDP, and TOTM. DOP (dioctyl phthalate, di-2-ethylhexyl phthalate), DINP (diisononyl phthalate), TOTM (trioctyl trimellitate) or DINP (diisodecyl phthalate).

### DETAILED DESCRIPTION

Frequently employed are external plasticizers, which are not bonded covalently into the polymer but instead interact with the polymer via polar groups, in order to allow the polymeric chains to be mobile, such as, for example, diethylhexyl phthalate (DEHP), and dioctyl phthalate (DOP) as plasticizers for PVC and elastomers. Further plasticizers include citric acid-based plasticizers such as triethyl citrate or adipic acid-based plasticizers such as diethylhexyl adipate and diethyloctyl adipate. The diffusion of these external plasticizers from the plastics of the cable insulation may be reduced significantly by the adhesive tapes of the invention with PSAs.

The internal plasticizers are understood as those which are present and are copolymerized during the copolymerization, and which are subsequently unable to diffuse out of the polymer.

For easier metering it is advantageous to add the organically modified, more particularly nanodisperse phyllosilicates in the form of a completed dispersion to the PSAs or the acrylate dispersions. For this purpose, the dispersions can be incorporated with stirring into the PSA or adhesive dispersion without being subjected to high shearing forces. The organically modified phyllosilicates may alternatively be added in the form of solids. Within the PSA, the organically modified phyllosilicates in the fully dried PSA take the form of exfoliated, platelet-shaped crystals.

It has been ascertained that through the use of Laponite SL25 as a barrier layer in the PSA, the cable coloring remains perceptible for longer. This is rated as a safety aspect, since the embrittlement and aging of the cable is reduced. In the case of repair work, moreover, this is a significant aid to working, since the cables must be replaced less frequently and remain more flexible.

Other advantages of the modified phyllosilicates are that Laponite SL25 also acts as a thickener for the aqueous dispersions and therefore functions additionally as a processing assistant. The dispersions thus prepared can therefore be applied with any of a wide variety of coating assemblies onto carrier materials, since the spectrum of adjustable viscosities is large and adjustment can easily be accomplished via the level of addition of the modified phyllosilicates. Possible coating assemblies include coating knife, comma bar, air knife, roll, Meyer bar, nozzle, etc. As already stated, acrylate dispersions can very easily be blended with predispersed phyllosilicates by stirred incorporation.

Surprisingly, the finely disperse phyllosilicates may also be used for producing electrically conductive, antistatic coatings. This field of application is of particular interest for electrically conductive adhesive tape applications as in the case of electromagnetic shielding. This quality may be attributed to the high physical surface area of the synthetic phyllosilicates, which may have surface areas of up to 1000 m²/g.

On account of their crystal morphology, these phyllosilicates may also perform a barrier function. Another subject of the invention, therefore, is an adhesive tape and a pressure-sensitive adhesive comprising modified synthetic phyllosilicates having a barrier function with respect to plasticizers from cable insulation, and also a corresponding use.

The acrylate dispersion used in the PSA in accordance with the invention comprises polymers which are constructed of monomeric acrylates and optionally ethylenically unsaturated comonomers which are not acrylates; the dried and non-EBC-crosslinked acrylate dispersion preferably has a gel value of greater than or equal to 40%. Monomeric acrylates are understood presently to be those acrylates in which the acrylate possesses a carbonyl group (C═O) such as, preferably all monomeric acrylates having an optionally functionalized parent structure C═C—(C═O)—, and so acrylamides are reckoned among the acrylates, and acrylonitriles are reckoned among the ethylenically unsaturated comonomers.

Phyllosilicates, or alternatively sheet silicates or layered silicates, are known for use as ion exchangers. Known phyllosilicates are clay minerals such as montmorillonite, nontronite, hectorite, saponite, sauconite, beidellite, allevardite, illite, halloysite, attapulgite and/or sepiolite, and also disteardimonium hectorite. Hectorites are M_{0.3}⁺(Mg_{2.7}Li_{0.3})[Si₄O₁₀(OH)₂], M⁺ usually=Na⁺, monoclinic clay mineral belonging to the smectites and similar to montmorillonite. Inventively preferred are modified three-layer phyllosilicates or, used synonymously here, modified three-layer clay minerals such as, for example, illites, smectites, or vermiculites. With particular preference the following modified phyllosilicates—montmorillonite, hectorite or smectite—are used in the PSAs of the invention.

According to manufacturers, the full activity of the unmodified phyllosilicates may be developed by activation with polar additives and high shearing forces (for example, product information on Tixogel® VP-V (Quaternium-90 Bentonite) from Rockwood Additives Ltd, or on Bentone® 38 (organic derivative of a magnesium phyllosilicate (hectorite)) from Rheox Inc).

This activation of the phyllosilicates, namely conversion into a swellable form, is accomplished by treating the phyllosilicates with a polar liquid and high shearing forces. The resultant phyllosilicates are considered to be modified phyllosilicates. Modified phyllosilicates may equally well be used under the name Laponite®, Optigel®, Laponite SL 25®, Laptonite S482®, Laptonite EP®, Laptonite RDS®, Optigel CK® from Rockwood. Preference is given to the natural and synthetic, organically surface-modified three-layer phyllosilicates.

The PSA preferably comprises an acrylate dispersion which preferably comprises an aqueous acrylate dispersion, comprising polymers constructed of
a) greater than or equal to 40 wt % of monomeric acrylates and
b) 0 to 60 wt % of ethylenically unsaturated comonomers, where the monomeric acrylates comprise mono-, di- and/or polyfunctional acrylates and where the ethylenically unsaturated comonomers are selected from ethylene-containing monomers, vinyl-functional monomers, and unsaturated hydrocarbons having 3 to 8 C atoms, based on the polymers.

The acrylate dispersions, more particularly aqueous acrylate dispersions, contrast with the acrylate hotmelts and solvent-based acrylates in still comprising, to a certain degree, separation of the polymer coils which originate from the individual dispersion beads (see, among other references, BASF-Handbuch Lackiertechnik, Artur Goldschmidt, Hans-Joachim Streitberger, 2002, section 3.1.2.1, FIG. 3.1.5, p. 337 ff.).

In the case of acrylate dispersions, the high gel fraction means that no rational determination of the molecular weight is possible. The high gel fraction results from the chain transfer reactions in the dispersion particles. In the case of emulsion polymerization in particular, the probability of such crosslinking is high, since only growing polymer chains and monomers are present in the dispersion particles, and so this crosslinking is greatly increased relative to solution polymerization. The particular feature of the acrylate dispersions, especially of the aqueous acrylate dispersions, is that this kind of crosslinking in the confined sphere of the dispersion particles produces branched molecules having a high molecular weight. The high gel value of the acrylate dispersions is also a good descriptor of the situation whereby they can frequently be used without further crosslinking as PSAs. This is in contrast to acrylate hotmelts or solvent-based acrylate adhesives, which as a general rule must be aftercrosslinked. Typical acrylate hotmelt adhesives have a low gel value of 10%.

In contrast, the polymeric acrylate dispersions used in the PSAs of the invention, more particularly dried, originally aqueous acrylate dispersions, have a gel value of greater than or equal to 40%, which can be determined by means of Soxhlet extraction, more particularly of greater than or equal to 45%. Typical acrylate dispersions of the kind employable in accordance with the invention are described in DE 10 2011 075 156 A1, DE 10 2011 075 159 A1, DE 10 2011 075 152 A1, and DE 10 2011 075 160 A1. Full reference is made to these specifications in relation to the acrylate dispersions employable in accordance with the invention. These acrylate dispersions, moreover, are elucidated in detail below.

One particular advantage of the PSAs of the invention comprising modified phyllosilicates and acrylate dispersions, optionally resin-blended acrylate dispersions, lies in the simple and economic possibility for individual fine-tuning of the PSA via the nature and quantity of the modified phyllosilicates, and also in the simple and economically individual possibility of tuning the acrylate dispersions to the particular requirements and to the desired carrier material. A second advantage is that, optionally, any crosslinking of the resin-modified acrylate dispersions that may be desired after drying can easily take place in the coating operation from the adhesive side by means of EBC, in order to bring about the optimum of cohesion and adhesion (see FIG. 10).

An essential advantage which is manifested in the properties of the acrylate dispersions is that in contrast to hotmelt adhesives and solvent-based adhesives, the acrylate dispersions to a certain degree retain separation of the polymer coils which originate from the individual dispersion beads.

As a result of the inventive possibility of EBC irradiation, there is a wide-meshed crosslinking within the polymer coils, leading to an increase in the molecular weight within the polymer coils. Advantageously there is virtually no crosslinking between the polymer coils, and so the composition remains highly flowable and allows effective wetting of the adhesion base (substrate). This phenomenon can be demonstrated by means of rheological investigations (such as DMA, Dynamic Mechanical Analysis).

Particular advantages are afforded by the PSAs of the invention comprising (i) acrylate dispersions and (ii) modified phyllosilicates by means of very simple blendability with predispersed resins, auxiliaries, fillers, aging inhibitors, etc. It is in fact possible to formulate the PSAs for use in accordance with the invention, comprising acrylate dispersions, in such a way that even without additional crosslinking (EBC crosslinking), but in the presence of the modified phyllosilicates, they afford sufficient cohesion and at the same time can be employed with good values for unwind forces on completed adhesive-tape rolls.

Another subject of the invention is an adhesive tape in accordance with the aforesaid features, with a TFT (Threshold Flagging Time) after optional electron beam crosslinking (EBC) of preferably greater than or equal to 1000 minutes, more particularly greater than or equal to 1500, preferably greater than or equal to 1700, more preferably greater than or equal to 2000 minutes, preferably greater than or equal to 2500 minutes.

A key advantage of the inventively employed PSAs comprising acrylate dispersions and modified phyllosilicates is evident from the low appropriate electron beam doses of more preferably greater than or equal to 5 kGy to 10 kGy, more particularly 10 to 20 kGy, 20 to 30 kGy, 30 to 40 kGy, alternatively more preferably from 35 to 45 kGy or else greater than or equal to 40 up to a maximum of 50 kGy, usefully up to 80 kGy. These are sufficient, particularly as an EBC dose from the adhesive side, to obtain TFT values, depending on the carrier material used and on the particular PSA, of greater than 1500 minutes, preferably of greater than 2000 minutes, more preferably of greater than or equal to 2100, very preferably of greater than or equal to 2200, preferably TFT values of greater than or equal to 2500 or even of greater than or equal to 3000 and greater than or equal to 4000 minutes.

Adhesive tapes of the invention also have a flagging behavior, measured as the length of the upstanding tape end according to LV 312, of less than or equal to 4 mm, preferably less than or equal to 3 mm, more preferably less than or equal to 2 mm, preferably less than or equal to 1 mm, or no flagging, in each case with a tolerance of plus/minus 0.5 mm, preferably plus/minus 0.2 mm.

Another subject of the invention is an adhesive tape having a PSA which is applied on one side of the carrier and whose coatweight is less than or equal to 120 g/m², more particularly less than or equal to 100 g/m², preferably less than or equal to 90 g/m², more preferably less than or equal to 80 g/m², more preferably less than or equal to 70 g/m², and, in alternatives, also less than or equal to 60 g/m² and less than or equal to 50 g/m², in each case with a tolerance of plus/minus 2 g/m², preferably with plus/minus 1 g/m², with TFT values of 1000 minutes already being achievable, preferably, with the non-EBC-crosslinked PSAs.

An advantageous feature of adhesive tapes of the invention is that the TFT (Threshold Flagging Time) after electron beam crosslinking in comparison to the TFT before electron beam crosslinking (EBC) is greater by a factor of approximately 2. For this purpose, low EBC doses of less than or equal to 40 kGy are preferably enough, more particularly less than or equal to 35 kGy, very preferably less than or equal to 30 kGy, more preferably of less than or equal to 20 kGy, down to less than or equal to 10 kGy.

A further subject of the invention are also adhesive tapes having a PSA which is applied on one side of the carrier and comprises modified phyllosilicates, and having a carrier which is impregnated with an additional acrylate dispersion, this acrylate dispersion not being counted in the coatweight of the PSA. The impregnation may be applied with a coatweight of less than or equal to 30 g/m², more particularly less than or equal to 25 g/m², preferably less than or equal to 20 g/m², more preferably less than or equal to 10 g/m², in each case with a fluctuation of plus/minus 5 g/m². A feature of the acrylate dispersions used for the impregnation is that in the dried state they preferably have only very low pressure-sensitive adhesive properties or none. Therefore, acrylate dispersions or else, optionally, polyurethane, rubber-based or SBR impregnations can be used which in the dried state preferably have only very slight pressure-sensitive adhesive properties or none. This prevents blocking of the layers on the bale. Optionally it is possible to use acrylate dispersions of the invention with slight pressure-sensitive properties or none, in other words without resins.

With the PSAs of the invention comprising (i) dried acrylate dispersions and (ii) modified phyllosilicates and including a tackifier as well, very good flagging-free products, with good unwindability and with low acrylate-dispersion coatweight can be obtained even with carrier materials whose basis weights are varied over wide ranges such as from 30 to 250 g/m², preferably from 50 to 200 g/m², more preferably from 60 to 150 g/m², and/or whose flexural stiffnesses vary in the range from 0 to 30 mN/60 mm as carrier stock (MD, Machine Direction), optionally from 2 to 30 mN/60 mm as carrier stock (MD), and hence also whose flexural stiffness is sharply different.

It is also preferred if the adhesive tapes constitute a combination of woven fabric carrier and pressure-sensitive adhesive, with the woven fabric carrier having a basis weight of 50 to 250 g/m², preferably of 60 to 150 g/m², and the PSA having a coatweight of 30 to 150 g/m², preferably of 50 to 150 g/m², the carrier more preferably being a woven PET fabric.

Also preferred are adhesive tapes featuring a nonwoven carrier/PSA combination, the nonwoven carrier having a basis weight of 30 to 250 g/m², preferably of 60 to 150 g/m², and the PSA having a coatweight of 20 to 150 g/m², preferably of 50 to 150 g/m².

A particular advantage of the adhesive tapes in accordance with the invention is that because of the electron beam crosslinking (EBC), the viscosity of the PSA remains essentially unchanged, or the electron beam crosslinking of polymers takes place essentially within the polymer coils, with an increase in the molecular weight of the polymers in the polymer coils by comparison with the unirradiated polymer coils; in particular, the electron beam crosslinking of the polymers between the polymer coils is smaller by comparison with the electron beam crosslinking within the polymer coils, and is preferably negligible. This can be detected via DMA values, with the aid of the viscosity profiles of EBC-crosslinked and uncrosslinked specimens, evaluated over a defined frequency range from 0.1 to 100 rad/s. This can equally be represented using the gel values before and after the EBH crosslinking, which are both situated in the range from 40% to 60%, preferably between 40% to 50% or between 44% to 50%, the possible measurement inaccuracy being plus/minus 3%.

According to preferred embodiments, the adhesive tape, more particularly for the wrapping of cables, comprises a carrier and a pressure-sensitive adhesive which is applied on at least one side of the carrier and which comprises (i) a dried acrylate dispersion and also (ii) modified phyllosilicates, where the acrylate dispersion, more particularly the undried acrylate dispersion, comprises polymers which are constructed of or obtainable from
(I) a) monomeric acrylates selected from 40 to 90 wt % of n-butyl acrylate, 2-ethylhexyl acrylate and/or ethyl acrylate and 0 to 2 wt % of a di- or polyfunctional monomer, more preferably 0 to 1 wt % of a di- or polyfunctional monomer,
b) ethylenically unsaturated comonomers at 10 to 60 wt %, selected from at least one ethylenically unsaturated monofunctional monomer or mixture thereof and 0 to 10 wt % of an ethylenically unsaturated monomer having an acid or acid-anhydride function, or
(II) a) monomeric acrylates selected from 90 to 99 wt % of n-butyl acrylate and/or 2-ethylhexyl acrylate and 0 to 2 wt % of a di- or polyfunctional monomer, more preferably 0 to 1 wt % of a di- or polyfunctional monomer,
b) ethylenically unsaturated comonomers at 10 to 1 wt %, selected from at least one ethylenically unsaturated monofunctional monomer or mixture thereof and 0 to 10 wt % of an ethylenically unsaturated monomer having an acid or acid-anhydride function,
   or
(III) a) monomeric acrylates selected from 30 to 75 wt %, preferably 40 to 60 wt % of alkyl acrylic esters having C₄ to C₁₂ alkyl radicals,
b) ethylenically unsaturated comonomers at 5 to 25 wt %, preferably 10 to 22 wt % of ethylene, 20 to 55 wt %, preferably 28 to 38 wt %, of vinyl acetate, and 0 to 10 wt % of other ethylenically unsaturated compounds;
   where the acrylate dispersion is prepared by reacting the monomers as per (I), (II) and/or (III) in an emulsion polymerization, based in each case on the polymers (expressed as 100 wt %) in the acrylate dispersion. It is particularly preferred here if the PSA comprises between 30 and 50 parts by weight of a tackifier (based on the mass of the dried polymeric dispersion), more preferably rosin ester resin. Another subject of the invention are the stated PSAs comprising organically modified phyllosilicates. It is particularly preferred here if the modified phyllosilicates in the PSAs of the invention are swellable.

According to further preferred embodiments, the adhesive tape, more particularly for the wrapping of cables, comprises a carrier and a pressure-sensitive adhesive which is applied on at least one side of the carrier and comprises (i) a dried acrylate dispersion and also (ii) modified phyllosilicates, where the acrylate dispersion, more particularly the undried acrylate dispersion, comprises polymers which are constructed of or obtainable from a) monomer acrylates selected from alkyl (meth)acrylates, preferably C₁ to C₂₀ alkyl (meth)acrylates, C₁ to C₁₀ hydroxyalkyl (meth)acrylates such as, in particular, hydroxyethyl or hydroxypropyl (meth)acrylate, acid amides such as acrylamide or methacrylamide, and also mixtures of two or more of the monomers, and of/from b) monomeric comonomers selected from ethylene, aromatic vinyl monomers such as styrene, a-methylstyrene and vinyltoluene, divinylbenzene, vinyl esters of carboxylic acids containing up to 20 carbon atoms, such as vinyl laurate, vinyl ethers of alcohols containing up to 10 carbon atoms, such as vinyl methyl ether or vinyl isobutyl ether, vinyl halides such as vinyl chloride or vinylidene dichloride, itaconic acid, maleic acid, fumaric acid and/or maleic anhydride, acrylonitrile and/or methacrylonitrile, unsaturated hydrocarbons having 3 to 8 carbon atoms such as propene, butadiene, isoprene, 1-hexene or 1-octene, and also mixtures of two or more comonomers.

According to further preferred embodiments, the adhesive tape, more particularly for the wrapping of cables, comprises a carrier and a pressure-sensitive adhesive which is applied on at least one side of the carrier and comprises (i) a dried acrylate dispersion and (ii) modified phyllosilicates, where the acrylate dispersion comprises polymers which are constructed of or obtainable from a) monomer acrylates selected from acrylic acid or methacrylic acid, n-butyl acrylate, ethyl acrylate, and 2-ethylhexyl acrylate, and also mixtures of two or more monomers, and di- or polyfunctional monomers selected from alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, and triacrylates such as trimethylolpropane triacrylate, and tetraacrylates such as pentaerythritol tetraacrylate, and also, optionally in combination with the monomeric comonomers specified under b).

The invention accordingly further relates to an adhesive tape, more particularly for wrapping cables, which consists of a preferably textile carrier and a pressure-sensitive adhesive which is applied on at least one side of the carrier and is in the form of a dried polymer dispersion, the polymer being constructed of:
(a.1) 40 to 90 wt % of n-butyl acrylate and/or 2-ethylhexyl acrylate,
(a.2) 60 to 10 wt % of one or more non-(a.1) ethylenically unsaturated monofunctional acrylate monomers, and
(a.3) 0 to 1 wt % of a di- or polyfunctional acrylate monomer,
(b.1) 0 to 10 wt % of an ethylenically unsaturated monomer having an acid or acid-anhydride function that is not an acrylate, and/or
(a.4) 0 to 5 wt % of an ethylenically unsaturated acrylate monomer having an acid or acid-anhydride function
   and the pressure-sensitive adhesive comprises between 15 and 100 parts by weight of a tackifier (based on the mass of the dried polymer dispersion).

Preferred is ethyl acrylate as monomer (a.2) or at least part of the monomers (a.3). Preferred as monomer (a.1) is 2-ethylhexyl acrylate. According to another preferred embodiment, the monomer (a.1) consists of 2-ethylhexyl acrylate and at the same time the monomer (a.2) or at least part of the monomers (a.3) consists of ethyl acrylate. Very preferably the polymer is constructed of (a.1) 40 to 60 wt % of 2-ethylhexyl acrylate, (a.2) 60 to 40 wt % of ethyl acrylate, (a.3) 0 to 0.5 wt % of a di- or polyfunctional monomer, (b) 0 to 5 wt % of an ethylenically unsaturated monomer having an acid or acid-anhydride function and/or (a.4) 0 to 5 wt % of an ethylenically unsaturated acrylate monomer having an acid or acid-anhydride function.

Contemplated advantageously as monomer (b.1) are, for example, itaconic acid, maleic acid, fumaric acid and/or maleic anhydride, and/or, as monomers (a.4), 0 to 5 wt % of an ethylenically unsaturated acrylate monomer having an acid or acid-anhydride function such as, preferably, acrylic acid, methacrylic acid. Preferred are acrylic acid or methacrylic acid, optionally the mixture of both.

An example of a polyfunctional ethylenically unsaturated monomer (b.1) is divinylbenzene, and examples of ethylenically unsaturated acrylate monomers having an acid or acid-anhydride function (a.4) are alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate, and tetraacrylates such as pentaerythritol tetraacrylate.

Monomers (a.2) encompass alkyl (meth)acrylates, preferably C₁ to C₂₀ alkyl (meth)acrylates, C₁ to C₁₀ hydroxyalkyl (meth)acrylates such as, in particular, hydroxyethyl or hydroxypropyl (meth)acrylate, acid amides such as acrylamide or methacrylamide except for the (b)-forming monomers, aromatic vinyl monomers such as styrene, α-methylstyrene and vinyltoluene, vinyl esters of carboxylic acids containing up to 20 carbon atoms, such as vinyl acetate or vinyl laurate, vinyl ethers of alcohols containing up to 10 carbon atoms, such as vinyl methyl ether or vinyl isobutyl ether, vinyl halides such as vinyl chloride or vinylidene dichloride, and unsaturated hydrocarbons having 2 to 8 carbon atoms such as ethylene, propene, butadiene, isoprene, 1-hexene or 1-octene. Particularly preferred in accordance with the invention is ethyl acrylate.

Examples of polyfunctional ethylenically unsaturated monomers (a.3) are alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate, and tetraacrylates such as pentaerythritol tetraacrylate.

The polymer dispersion is prepared by the process of emulsion polymerization of the stated components. Descriptions of this process are given for example in “Emulsion Polymerization and Emulsion Polymers” by Peter A. Lovell and Mohamed S. El-Aasser—Wiley-VCH 1997—ISBN 0-471-96746-7 or in EP 1 378 527 B1.

Acrylate PSAs of the invention may typically be radically polymerized copolymers of alkyl acrylates or alkyl methacrylates of C₁ to C₂₀ alcohols such as, for example, as monomers a) methyl acrylate, ethyl (meth)acrylate, n-butyl (meth)acrylate, tert-butyl (meth)acrylate, cyclohexyl (meth)acrylate, 2-ethylhexyl (meth)acrylate, n-octyl (meth)acrylate, isooctyl (meth)acrylate, n-decyl (meth)acrylate, n-dodecyl (meth)acrylate, tetradecyl (meth)acrylate, lauryl (meth)acrylate, oleyl (meth)acrylate, palmityl (meth)acrylate, and stearyl (meth)acrylate, as well as other (meth)acrylic esters such as isobornyl (meth)acrylate, benzyl (meth)acrylate, phenyl (meth)acrylate, and 2-bromoethyl (meth)acrylate, alkoxyalkyl (meth)acrylates such as ethoxyethyl (meth)acrylate, or else acid amides such as acrylamide or methacrylamide.

Also belonging to the comonomers for preparing the acrylate dispersions b) are esters of ethylenically unsaturated dicarboxylic and tricarboxylic acids and anhydrides such as ethyl maleate, dimethyl fumarate, and ethyl methylitaconate, and also vinylaromatic monomers such as, for example, styrene, vinyltoluene, methylstyrene, n-butylstyrene, decylstyrene. Suitable for influencing the physical and optical properties of the PSA are polyfunctional ethylenically unsaturated monomers b) as crosslinker monomers, an example being divinylbenzene.

Further possible monomers (b.1) for obtaining the advantageous properties are vinyl esters of carboxylic acids containing up to 20 carbon atoms, such as vinyl acetate or vinyl laurate, vinyl ethers of alcohols containing up to 10 carbon atoms, such as vinyl methyl ether or vinyl isobutyl ether, vinyl halides such as vinyl chloride or vinylidene dichloride, nitriles such as acrylonitrile or methacrylonitrile, and unsaturated hydrocarbons having 2 to 8 carbon atoms such as ethylene, propene, butadiene, isoprene, 1-hexene or 1-octene.

To influence the physical and optical properties of the PSA, suitability is possessed by polyfunctional ethylenically unsaturated acrylate monomers (a.4) in a) as crosslinker monomers. Examples thereof are alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate, and tetraacrylates such as pentaerythritol tetraacrylate. The group of these polyfunctional monomers also includes UV-crosslinkable monomers such as, for example, (meth)acrylate-functionalized derivatives of benzophenone or of benzoin.

Another group of a) acrylate monomers are those which generate a latent crosslinking potential in the polymer and lead spontaneously (often with catalysis) to construction of a network after the adhesive has been dried. One such monomer, for example, is glycidyl methacrylate, whose oxirane ring, with hydroxyl functions or, more particularly, carboxylate functions, leads to a covalent bond, accompanied by ring opening. This reaction takes place in accelerated form in the presence of zinc ions or, especially, in the presence of carboxyl functions and/or amines.

In order to obtain pressure-sensitive adhesive properties, the processing temperature of the adhesive must be above its glass transition temperature for it to possess viscoelastic properties.

Typical particle sizes of the dispersed polymers of the invention range from 20 nm up to 10 μm. The polymer dispersion is prepared by the process of emulsion polymerization of acrylate monomers and possibly further ethylenically unsaturated monomers.

The shear viscosities of commercial dispersions are generally too low. To obtain the necessary shear viscosities, rheological additives, also called thickeners, are normally used.

A fundamental distinction is made here between organic and inorganic rheological additives.

The organic thickeners divide in turn into two essential modes of action: (i) the thickening of the aqueous phase, i.e., non-associating, and (ii) association between thickener molecule and particles, in part with incorporation of the stabilizers (emulsifiers). Representatives of the first (i) group are water-soluble polyacrylic acids and polycoacrylic acids, which in the basic medium form polyelectrolytes of high hydrodynamic volume. The skilled person also refers to these for short as ASE (alkali swellable emulsion). They are distinguished by high resting shear viscosities and strong shear thinning. Another class of compound are the modified polysaccharides, especially cellulose ethers such as carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxpropylcellulose, 2-hydroxypropylmethylcellulose, 2-hydroxybutylmethylcellulose. Additionally included in this class of compound are less-widespread polysaccharides such as starch derivatives and specific polyethers. The active group of the (ii) associative thickeners are, in principle, block copolymers having a water-soluble middle block and hydrophobic end blocks, the end blocks interacting with the particles or with themselves and so forming a three-dimensional network with incorporation of the particles. Typical representatives are familiar to the skilled person as HASE (hydrophobically modified alkali swellable emulsion), HEUR (hydrophobically modified ethylene oxide urethane) or HMHEC (hydrophobically modified hydroxyethylcellulose). In the case of the HASE thickeners, the middle block is an ASE, and the end blocks are usually long, hydrophobic alkyl chains coupled on via polyethylene oxide bridges. In the case of the HEUR, the water-soluble middle block is a polyurethane, and in the HMHEC it is a 2-hydroxyethylcellulose. The nonionic HEUR and HMHEC, in particular, are largely insensitive to pH.

Depending on structure, the associative thickeners produce more or less a Newtonian (shear rate-independent) or pseudoplastic (shear-liquefying) flow behavior. Occasionally they also exhibit thixotropic character, meaning that the viscosity is subject not only to dependency on shearing force but also to dependency on time.

The inorganic thickeners are usually phyllosilicates of natural or synthetic origin, examples being hectorites and smectites. In contact with water, the individual layers part from one another. At rest, as a result of different charges on surfaces and edges of the platelets, they form a space-filling house-of-cards structure, resulting in high resting shear viscosities through to yield points. On shearing, the house-of-cards structure collapses and a marked drop in the shear viscosity is observed. Depending on charge, concentration, and geometrically dimensions of the platelets, the development of structure may take some time, and so with inorganic thickeners of this kind it is also possible to obtain thixotropy.

The thickeners can in some cases be stirred directly into the adhesive dispersion or in some cases are predispersed or prediluted advantageously in water beforehand. Typical use concentrations are 0.1 to 5 wt %, based on the solids.

Suppliers of thickeners are, for example, OMG Borchers, Omya, Byk Chemie, Dow Chemical Company, Evonik, Rockwood, or Münzing Chemie.

Very preferably the polymer is constructed of
(a.1) 40 to 60 wt % of 2-ethylhexyl acrylate
(b.1) 0 to 5 wt % of an ethylenically unsaturated monomer, more particularly (b.1) 0 to 5 wt % of an ethylenically unsaturated monomer having an acid or acid-anhydride function or instead of (b.1) as
(a.4) 0 to 5 wt % of an ethylenically unsaturated acrylate monomer having an acid or acid-anhydride function
(a.2) 60 to 40 wt % of ethyl acrylate or instead of (a.2) a
(b.2) ethylenically unsaturated monomer which is not an acrylate,
(a.3) 0 to 0.5 wt % of a di- or polyfunctional monomer.

As monomer (b.2) aromatic vinyl monomers such as styrene, α-methylstyrene and vinyltoluene, vinyl esters of carboxylic acids containing up to 20 carbon atoms, such as vinyl acetate or vinyl laurate, vinyl ethers of alcohols containing up to 10 carbon atoms, such as vinyl methyl ether or vinyl isobutyl ether, vinyl halides such as vinyl chloride or vinylidene dichloride, and unsaturated hydrocarbons having 2 to 8 carbon atoms such as ethylene, propene, butadiene, isoprene, 1-hexene or 1-octene.

In order to obtain pressure-sensitive adhesive properties, the adhesive must be above its glass transition temperature at the processing temperature in order to have viscoelastic properties. Since cable loom wrapping takes place at normal ambient temperature (approximately between 15° C. to 25° C.), the glass transition temperature of the PSA formulation (polymer-tackifier mixture) is preferably below +15° C. (determined by DSC (Differential Scanning calorimetry) in accordance with DIN 53 765 with a heating rate of 10 K/min).

A further particularly preferred embodiment of the invention thus comprises a mixture of 2-ethylhexyl acrylate as monomer (a.1) and also ethyl acrylate as monomer (a.2) and terpene phenols and/or rosin esters having a softening point above 90° C. according to ASTM E28-99 (2009).

Particularly preferred compositions comprise, for example:
Polymer 1
   50 wt % 2-ethylhexyl acrylate
   2 wt % acrylic acid
   48 wt % ethyl acrylate
Polymer 2
   81 wt % 2-ethylhexyl acrylate
   1 wt % acrylic acid
   18 wt % methyl acrylate
Polymer 3
   84 wt % butyl acrylate
   1 wt % acrylic acid
   8 wt % methyl acrylate
   7 wt % vinyl acrylate

The PSAs listed were formulated from polymer 1 by blending with tackifier resin dispersions. The number indicates the parts by weight of tackifier per 100 parts by weight of polymer 1 (based in each case on solids).

Exemplary adhesive formulations from polymer 1 are prepared as follows:
B1 with 45 parts of Snowtack 100 G rosin ester resin, Lawter
B2 with 40 parts of Snowtack 780 G rosin ester resin, Lawter
B3 with 35 parts of Dermulsene TR 602 terpene-phenolic resin, DRT
B4 from polymer 2, blended with 40 parts by weight of the rosin ester resin Snowtack 100 G with a softening point of 99° C., and
   B5 from polymer 3, blended with 40 parts by weight of the rosin ester resin Snowtack 100 G with a softening point of 99° C.

According to a further embodiment, the polymeric acrylate dispersion comprises polymers of:
(a.1) 90 to 99 wt % of n-butyl acrylate and/or 2-ethylhexyl acrylate,
(b.1) 0 to 10 wt % of an ethylenically unsaturated monomer, more particularly 0 to 10 wt % of an ethylenically unsaturated monomer having an acid or acid-anhydride function, or instead of (b.1) as
(a.4) 0 to 5 wt % of an ethylenically unsaturated acrylate monomer having an acid or acid-anhydride function
(a.2) 10 to 1 wt % of one or more non-(a.1) ethylenically unsaturated monofunctional acrylate monomers or instead of (a.2) a
(b.2) ethylenically unsaturated monomer which is not an acrylate,
(a.3) 0 to 1 wt % of a di- or polyfunctional acrylate monomer and the PSA comprises between 15 and 100 parts by weight of a tackifier (based on the mass of the dried polymer dispersion).

Preferably 10 to 1 wt % of acrylonitrile and/or methacrylonitrile constitute the monomer (b.2) or at least part of the monomers (b.2), more preferably acrylonitrile. Preferably 2-ethylhexyl acrylate constitutes monomer (a.1).

According to a further preferred embodiment, the monomer (a.1) consists of 2-ethylhexyl acrylate and at the same time the monomer (b.2) or at least part of the monomers (b.2) consists of acrylonitrile and/or methacrylonitrile, preferably of acrylonitrile.

A particularly preferred embodiment of the invention thus comprises a mixture of 2-ethylhexyl acrylate as monomer (a.1) and acrylonitrile as monomer (b.2).

Contemplated advantageously as monomer (a.4) are, for example, acrylic acid, methacrylic acid. Acrylic acid or methacrylic acid are preferred, optionally the mixture of both. Alternatively, itaconic acid, maleic acid, fumaric acid and/or maleic anhydride, for example, are contemplated advantageously as monomer (b.1).

Monomers (a.2) embrace alkyl (meth)acrylates, preferably C₁ to C₂₀ alkyl (meth)acrylates with the exception of the monomers forming (a.1), C₁ to C₁₀ hydroxyalkyl (meth)acrylates such as, in particular, hydroxyethyl or hydroxypropyl (meth)acrylate, and acid amides such as acrylamide or methacrylamide. Particularly preferred in accordance with the invention is acrylonitrile.

Monomers (b.2) further embrace aromatic vinyl monomers such as styrene, a-methylstyrene, and vinyltoluene, vinyl esters of carboxylic acids containing up to 20 carbon atoms, such as vinyl acetate or vinyl laurate, vinyl ethers of alcohols containing up to 10 carbon atoms, such as vinyl methyl ether or vinyl isobutyl ether, vinyl halides such as vinyl chloride or vinylidene dichloride, and unsaturated hydrocarbons having 2 to 8 carbon atoms, such as ethylene, propene, butadiene, isoprene, 1-hexene or 1-octene, acrylonitrile and methacrylonitrile.

Examples of polyfunctional ethylenically unsaturated monomers (a.3) are alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate, and tetraacrylates such as pentaerythritol tetraacrylate. Alternatively as (b) 0 to 1 wt % of divinylbenzene.

Exemplary compositions of the polymer dispersions are as follows:

| | | |
|---|---|---|
| Polymer 1 | 93 | wt % 2-ethylhexyl acrylate |
| | 4 | wt % acrylic acid |
| | 3 | wt % acrylonitrile |
| Polymer 2 | 92 | wt % 2-ethylhexyl acrylate |
| | 2 | wt % acrylic acid |
| | 6 | wt % methyl methacrylate |
| Polymer 3 | 95 | wt % butyl acrylate |
| | 1 | wt % acrylic acid |
| | 4 | wt % vinyl acetate |

From polymer 1, the PSAs listed in table 1 were formulated by blending with tackifier resin dispersions.
B1 with 45 parts of Snowtack 100 G rosin ester resin, Lawter
B2 with 40 parts of Snowtack 780 G rosin ester resin, Lawter
B3 with 35 parts of terpene-phenolic resin
B4 from polymer 2, blended with 40 parts by weight of the rosin ester resin Snowtack 100 G with a softening point of 99° C., and
B5 from polymer 3, blended with 40 parts by weight of the rosin ester resin Snowtack 100 G with a softening point of 99° C.

In accordance with a further embodiment, the acrylate dispersions comprise polymers of:
(b.1) 5 to 25 wt %, preferably 10 to 22 wt %, of ethylene
(a.1) 30 to 75 wt %, preferably 40 to 60 wt %, of alkyl acrylic esters having C₄ to C₁₂ alkyl radicals
(b.3) 20 to 55 wt %, preferably 28 to 38 wt %, of vinyl acetate
(a.2) 0 to 10 wt % of other ethylenically unsaturated compounds or instead of (a.2) a
(b.2) ethylenically unsaturated monomer which is not an acrylate,
   and the PSA comprises between 15 and 100 parts by weight of a tackifier (based on the mass of the dried polymer dispersion).

The monomer (a.1) is preferably n-butyl acrylate and/or 2-ethylhexyl acrylate.

Monomers (a.2) embrace alkyl (meth)acrylates, preferably C₁ to C₂₀ alkyl (meth)acrylates, C₁ to C₁₀ hydroxyalkyl (meth)acrylates such as, in particular, hydroxyethyl or hydroxypropyl (meth)acrylate, acid amides such as acrylamide and/or methacrylamide.

Monomers (b.2) embrace (b)-forming monomers such as aromatic vinyl monomers such as divinylbenzene, styrene, a-methylstyrene, and vinyltoluene, vinyl esters of carboxylic acids containing up to 20 carbon atoms, such as vinyl laurate, vinyl ethers of alcohols containing up to 10 carbon atoms, such as vinyl methyl ether or vinyl isobutyl ether, vinyl halides such as vinyl chloride or vinylidene dichloride, and unsaturated hydrocarbons having 3 to 8 carbon atoms, such as propene, butadiene, isoprene, 1-hexene or 1-octene, or mixtures thereof. Divinylbenzene can be added at 0 to 1 wt %.

Furthermore, the polymer may advantageously have been admixed with, as monomer (a.3), a di- or polyfunctional monomer, preferably at 0 to 2 wt % and more preferably at 0 to 1 wt %. Examples of polyfunctional ethylenically unsaturated acrylate monomers are alkyl diacrylates such as 1,2-ethylene glycol diacrylate, 1,4-butanediol diacrylate, 1,6-hexanediol diacrylate, 1,8-octanediol diacrylate or 1,12-dodecanediol diacrylate, triacrylates such as trimethylolpropane triacrylate, and tetraacrylates such as pentaerythritol tetraacrylate.

The polymer dispersion is prepared by the process of emulsion polymerization with the stated components.

Composition of further example polymer dispersion: the example polymer dispersion was prepared according to example 1 of EP 0 017 986 B1 and contained accordingly

| | | |
|---|---|---|
| Polymer 1 | 46.7 | wt % 2-ethylhexyl acrylate |
| | 31.1 | wt % vinyl acetate |
| | 18 | wt % ethylene |
| | 2.6 | wt % acrylamide |
| | 1.6 | wt % acrylic acid |

From this polymer dispersion, PSAs were formulated as follows:
B1 with 45 parts of Snowtack 100 G, rosin ester resin, Lawter
B2 with 40 parts of Snowtack 780 G, rosin ester resin, Lawter
B3 with 35 parts of Dermulsene TR 602 terpene-phenolic resin, DRT

In order to obtain pressure-sensitive adhesive properties, the PSA must be above its glass transition temperature at the processing temperature in order to have viscoelastic properties. Since cable loom wrapping takes place at normal ambient temperature (approximately between 15° C. to 25° C.), the glass transition temperature of the PSA (acrylate dispersion with tackifier mixture) is preferably below +15° C. (determined by DSC (Differential Scanning calorimetry) in accordance with DIN 53 765 with a heating rate of 10 K/min).

The glass transition temperature of the acrylate copolymers can be estimated, according to the equation of Fox, from the glass transition temperatures of the homopolymers and their relative proportions (compare T. G. Fox, Bull. Am. Phys. Soc. 1 (1956) 123). The tackifiers inevitably raise the glass transition temperature, by around 5 to 40 K depending on amount added, compatibility, and softening temperature. Accordingly, only acrylate copolymers with a glass transition temperature of 0° C. at most are suitable.

In the wrapping of a cable loom, the adhesive tape is bonded with from no overlap at all to complete overlap around the cable, the radius of which is generally small, meaning that the adhesive tape is very sharply curved. At the end of a wrapped section, the tape is typically wrapped primarily onto its own reverse face, so that the degree of overlap is virtually complete, similarly to the customary presentation form as an adhesive tape roll, where the PSA is likewise bonded to its own reverse face. In the event of flagging, static forces are acting, such as, for example, through the flexural stiffness of the carrier and the wrapping tension, and may result in the open ends of adhesive tape standing up undesirably, similarly to the start of automatic unwinding. The flagging resistance, then, is the capacity of the PSA to withstand this static force.

The use of tackifiers to boost the peel adhesion of PSAs is known in principle. Consequently, the tackifiers that are added also contribute to the improved flagging resistance. The PSA of the invention is admixed preferably with greater than or equal to 15 to 100 parts by weight of tackifier (based on the mass of the dried polymeric dispersion), usually 20 to 80 parts by weight, more preferably 30 to 50 parts by weight.

Surprisingly and unforeseeably for the skilled person, the use of tackifier resins in the case of the adhesive tape of the invention does not lead at the same time to difficult unwind, despite the fact that a common factor of the two requirements is that the PSA has contact with its own reverse face.

Suitability as tackifiers, also referred to as tackifier resins, is possessed in principle by all known classes of compound. Tackifiers are, for example, hydrocarbon resins (for example polymers based on unsaturated C₅ or C₉ monomers), terpene phenolic resins, polyterpene resins based on raw materials such as, for example, α- or β-pinene, aromatic resins such as coumarone-indene resins or resins based on styrene or α-methylstyrene such as rosin and its derivatives, for example disproportionated, dimerized or esterified rosin, for example reaction products with glycol, glycerol or pentaerythritol, to name but a few. Preferred resins are those without readily oxidizable double bonds, such as terpene phenolic resins, aromatic resins, and more preferably resins produced by hydrogenation, such as hydrogenated aromatic resins, hydrogenated polycyclopentadiene resins, hydrogenated rosin derivatives or hydrogenated polyterpene resins, for example.

Preferred resins are those based on terpene phenols and rosin esters. Likewise preferred are tackifier resins having a softening point of more than 80° C. in accordance with ASTM E28-99 (2009). Particularly preferred resins are those based on terpene phenols and rosin esters having a softening point of more than 90° C. in accordance with ASTM E28-99 (2009). The resins are usefully employed in dispersion form. In that way they can easily be mixed in finely divided form with the polymer dispersion. Very preferably, rosin ester resins are added as tackifiers.

One particularly preferred embodiment of the invention, then, embraces a PSA comprising an acrylate dispersion of 2-ethylhexyl acrylate (monomer a.1) and also ethyl acrylate (monomer a.2) and terpene phenols and/or rosin esters having a softening point of more than 90° C. in accordance with ASTM E28-99 (2009).

To achieve further improvement in cable compatibility, the adhesive formulation may optionally be blended with light stabilizers or primary and/or secondary aging inhibitors. Aging inhibitors used may be products based on sterically hindered phenols, phosphites, thiosynergists, sterically hindered amines or UV absorbers. Preference is given to using primary antioxidants such as, for example, Irganox 1010 or Irganox 254, alone or in combination with secondary antioxidants such as, for example, Irgafos TNPP or Irgafos 168. These aging inhibitors may be used in any desired combination with one another, with mixtures of primary and secondary antioxidants in combination with light stabilizers such as Tinuvin 213, for example, exhibiting particularly good aging-inhibition effect.

Aging inhibitors in which a primary antioxidant is united with a secondary antioxidant in one molecule have proven to be especially advantageous. These aging inhibitors comprise cresol derivatives whose aromatic ring is substituted at two arbitrary, different locations, preferably in ortho- and meta-position relative to the OH group, by thioalkyl chains, it also being possible for the sulfur atom to be joined to the aromatic ring of the cresol building block via one or more alkyl chains. The number of carbon atoms between the aromatic moiety and the sulfur atom may be between 1 and 10, preferably between 1 and 4. The number of carbon atoms in the alkyl side chain may be between 1 and 25, preferably between 6 and 16. Particularly preferred in this context are compounds of the 4,6-bis(dodecylthiomethyl)-o-cresol, 4,6-bis(undecylthiomethyl)-o-cresol, 4,6-bis(decyl-thiomethyl)-o-cresol 4,6-bis(nonylthiomethyl)-o-cresol or 4,6-bis(octylthiomethyl)-o-cresol type. Aging inhibitors of these kinds are available for example from the company Ciba Geigy under the name Irganox 1726 or Irganox 1520.

The amount of the aging inhibitor or aging inhibitor package added ought to be situated within a range between 0.1 and 10% by weight, preferably in a range between 0.2 and 5% by weight, more preferably in a range between 0.5 and 3% by weight, based on the overall solids content.

Preference is given to the presentation form in the form of a dispersion for particularly simple miscibility with the adhesive dispersion. Alternatively it is also possible for liquid aging inhibitors to be incorporated directly into the dispersion, in which case the step of incorporation ought to be followed by a standing time of a number of hours, to allow the homogeneous distribution of the aging inhibitor in the dispersion or its acceptance into the dispersion particles. A further alternative is the addition of an organic solution of the aging inhibitors to the dispersion. Suitable concentrations lie in the range from 0.1 up to 5 parts by weight, based on the solids.

For improving the processing properties, the PSA for formulation may be blended with further customary process auxiliaries such as rheological additives (thickeners), defoamers, deaerating agents, wetting agents or flow control agents. Suitable concentrations are in the range from 0.1 up to 5 parts by weight, based on the solids.

Fillers (reinforcing or non-reinforcing) such as silicon dioxides (spherical, acicular, platelet-shaped or irregular like the fumed silicas), glass in the form of solid or hollow beads, microballoons, calcium carbonates, zinc oxides, titanium dioxides, aluminum oxides or aluminum oxide hydroxides may serve for fine-tuning the processing properties and also the technical adhesive properties. Suitable concentrations are in the range from 0.1 up to 20 parts by weight, based on the solids.

According to preferred embodiments, the PSA of the invention has an ASTM D3330 peel adhesion to steel of greater than or equal to 4.5 N/cm at a PSA coatweight of 100 g/m², preferably on a woven PET fabric carrier, more preferably having the stated basis weights of the fabric. More preferably the PSA has a peel adhesion of greater than or equal to at least 4.5 N/cm (for a PSA coatweight of 90 g/m² on woven polyester fabric carrier, preferably even at 80 g/m² as well, more preferably at 70 g/m² on woven polyester fabric carrier). With particular preference the PSA has an ASTM D3330 peel adhesion to steel of at least 5.0 N/cm (for a PSA coatweight of 90 g/m² on woven polyester fabric carrier), preferably greater than or equal to 5.2 N/cm, 5.3 N/cm, 5.4 N/cm, 5.5 N/cm, 5.6 N/cm or 5.7 N/cm, more preferably 5.7 to 6.0 N/cm.

Likewise a subject of the invention is an adhesive tape comprising a PSA, and also a PSA, which according to LV 312 preferably have an unwind force of 4.0 N/cm at 30 m/min, more particularly less than or equal to 3.9 to 2.0, very preferably less than or equal to 3.8 N/cm to 2.0 N/cm, preferably at the same time with a peel adhesion to steel of at least 4.5 N/cm according to ASTM D3330 (for a PSA coatweight of 100 g/cm² on woven polyester fabric carrier). The unwind force of the adhesive tapes of the invention can be adjusted in a targeted and precise way. This is of particular interest for adhesive cable bandaging tapes for application manually or by machine. The target figure for adhesive cable bandaging tapes which are applied by machine is less than 4 N/cm at 30 m/min, with the figures for manual application being 5 to 7 N/cm.

Another subject of the invention is an adhesive tape comprising a pressure-sensitive adhesive or a pressure-sensitive adhesive, which according to ASTM D3330 has a peel adhesion to the reverse face of the adhesive tape carrier of at least 3.0 N/cm (for a PSA coatweight of 90 g/m² on woven polyester fabric carrier). Preference is given to a peel adhesion to the reverse face of the adhesive tape carrier of greater than or equal to 2.0, more particularly greater than or equal to 3.0 N/cm, preferably greater than or equal to 3.3 N/cm, more preferably greater than or equal to 3.5, or with particular preference greater than or equal to 4.0 N/cm.

Another subject of the invention is an adhesive tape comprising pressure-sensitive adhesive with a TFT (Threshold Flagging Time) of greater than or equal to 700 minutes, the pressure-sensitive adhesive comprising modified phyllosilicates, preferably greater than or equal to 800 minutes, more preferably greater than or equal to 1000 minutes.

The amount of modified phyllosilicates in wt % is within the stated ranges, the amount of modified phyllosilicates in the PSA being more particularly between 0.1 to 5 wt % in the PSA overall, based on the dried polymeric dispersion; 0.2 to 2.5 wt % are preferred.

With preference in accordance with the invention the carrier is a textile carrier, preferably a woven fabric, more particularly a woven polyester fabric, a nonwoven web or knitted fabric, it being further preferred for the carrier to have a basis weight of 30 to 250 g/m², preferably of 50 to 200 g/m², more preferably 60 to 150 g/m².

As carrier it is possible to use all known textile carriers such as knitted fabrics, scrims, tapes, braids, tufted textiles, felts, woven fabrics (encompassing plain weave, twill and satin weave), knitted fabrics (encompassing warp knits and other knits) or nonwoven webs, the term “nonwoven web” comprehending at least sheetlike textile structures in accordance with EN 29092 (1988) and also stitchbonded webs and similar systems.

It is likewise possible to use woven and knitted spacer fabrics with lamination. Spacer fabrics of these kinds are disclosed in EP 0 071 212 B1. Spacer fabrics are mat-like layer structures comprising a cover layer of a fiber or filament web, an underlayer and individual retaining fibers or bundles of such fibers between these layers, these fibers being distributed over the area of the layer structure, being needled through the particle layer and joining the cover layer and the underlayer to one another. As an additional although not mandatory feature, the retaining fibers in accordance with EP 0 071 212 B1 contain particles of inert minerals, such as sand, gravel or the like, for example.

The retaining fibers needled through the particle layer hold the cover layer and the underlayer at a distance from one another and are joined to the cover layer and the underlayer.

Nonwovens contemplated include, in particular, consolidated staple fiber webs, but also filament webs, meltblown webs and spunbonded webs, which generally require additional consolidation. Possible consolidation methods known for webs include mechanical, thermal and chemical consolidation. Whereas with mechanical consolidations the fibers are held together purely mechanically usually by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to fiber nodal points, so that a stable, three-dimensional network is formed while nevertheless retaining the loose, open structure in the web.

Webs which have proven to be particularly advantageous are those consolidated in particular by overstitching with separate threads or by interlooping.

Consolidated webs of this kind are produced for example on stitchbonding machines of the “Malimo” type from the company Karl Mayer, formerly Malimo, and can be obtained from companies including Techtex GmbH. A Malifleece is characterized in that a cross-laid web is consolidated by the formation of loops from fibers of the web.

The carrier used may also be a web of the Kunit or Multiknit type. A Kunit web is characterized in that it originates from the processing of a longitudinally oriented fiber web to form a sheetlike structure which has loops on one side and has loop feet or pile fiber folds on the other side, but possesses neither threads nor prefabricated sheetlike structures. A web of this kind as well has been produced for a relatively long time, for example on stitchbonding machines of the “Malimo” type from the company Karl Mayer. A further characterizing feature of this web is that, as a longitudinal-fiber web, it is able to absorb high tensile forces in the longitudinal direction. The characteristic feature of a Multiknit web relative to the Kunit web is that the web is consolidated on both the top and bottom sides by virtue of the double-sided needle punching. The starting product used for a Multiknit is generally one or two single-sidedly interlooped pile fiber nonwovens produced by the Kunit process. In the end product, both top sides of the nonwovens are shaped by means of interlooped fibers to form a closed surface, and are joined to one another by fibers which stand almost perpendicularly. An additional possibility is to introduce further needlable sheetlike structures and/or scatterable media. Finally, stitchbonded webs as an intermediate are also suitable for forming a carrier of the invention and an adhesive tape of the invention. A stitchbonded web is formed from a nonwoven material having a large number of stitches extending parallel to one another. These stitches are brought about by the stitching-in or stitchbonding of continuous textile threads. For this type of web, stitchbonding machines of the “Malimo” type from the company Karl Mayer are known.

Also particularly suitable are needlefelt webs. In a needlefelt web, a tuft of fibers is made into a sheetlike structure by means of needles provided with barbs. By alternate introduction and withdrawal of the needles, the material is consolidated on a needle bar, with the individual fibers interlooping to form a firm sheetlike structure. The number and configuration of the needling points (needle shape, penetration depth, double-sided needling) determine the thickness and strength of the fiber structures, which are in general lightweight, air-permeable and elastic.

Also particularly advantageous is a staple fiber web which is mechanically preconsolidated in the first step or is a wet-laid web laid hydrodynamically, in which between 2% and 50% by weight of the web fibers are fusible fibers, more particularly between 5% and 40% by weight of the web fibers. A web of this kind is characterized in that the fibers are laid wet or, for example, a staple fiber web is preconsolidated by the formation of loops from fibers of the web by needling, stitching or air-jet and/or water-jet treatment. In a second step, thermofixing takes place, with the strength of the web being increased again by the melting, or partial melting, of the fusible fibers.

For the utilization of nonwovens in accordance with the invention, the adhesive consolidation of mechanically preconsolidated or wet-laid webs is of particular interest, it being possible for said consolidation to take place by way of the addition of binder in solid, liquid, foamed or paste-like form. A great diversity of theoretical presentation forms is possible: for example, solid binders as powders for trickling in; as a sheet or as a mesh; or in the form of binding fibers. Liquid binders may be applied as solutions in water or organic solvents, or as a dispersion. For adhesive consolidation, binding dispersions are predominantly selected: thermosets in the form of phenolic or melamine resin dispersions, elastomers as dispersions of natural or synthetic rubbers or, usually, dispersions of thermoplastics such as acrylates, vinyl acetates, polyurethanes, styrene-butadiene systems, PVC, and the like, and also copolymers thereof. Normally the dispersions are anionic or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for producing specific changes in surface properties. Such a procedure not only is sparing in its use of binder but also greatly reduces the energy requirement for drying. Since no squeeze rolls are required and the dispersions remain predominantly in the upper region of the nonwoven, unwanted hardening and stiffening of the web can be largely prevented. For sufficient adhesive consolidation of the web carrier, the addition of binder in the order of magnitude of 1% to 50%, more particularly 3% to 20%, based on the weight of the fiber web, is generally required.

The binder may be added as early as during the manufacture of the web, in the course of mechanical preconsolidation, or else in a separate process step, which may be carried out in-line or off-line. Following the addition of binder, it is necessary temporarily to generate a condition for the binder in which the binder becomes adhesive and adhesively connects the fibers—this may be achieved during the drying, for example, of dispersions, or else by means of heating, with further possibilities for variation existing by way of areal or partial application of pressure. The binder may be activated in known drying tunnels, given an appropriate selection of binder, or else by means of infrared radiation, UV radiation, ultrasound, high-frequency radiation or the like. For the subsequent end use it is sensible, though not absolutely necessary, for the binder to have lost its tack following the end of the web production process. It is advantageous that, as a result of thermal treatment, volatile components such as fiber assistants are removed, giving a web having favorable fogging values, so that when a low-fogging adhesive is used, it is possible to produce an adhesive tape having particularly favorable fogging values; accordingly, the carrier as well has a very low fogging value.

A further special form of adhesive consolidation involves activating the binder by partial dissolution or partial swelling. In this case it is also possible in principle for the fibers themselves, or admixed speciality fibers, to take over the function of the binder. Since, however, such solvents are objectionable on environmental grounds, and/or are problematic in their handling, for the majority of polymeric fibers, this process is not often employed.

Advantageously and at least in regions, the carrier has a single-sidedly or double-sidedly polished surface, preferably in each case a surface polished over the whole area. The polished surface may be chintzed, as elucidated in detail in EP 1 448 744 A1, for example. Soil repellency is thus improved.

Starting materials for the carrier are more particularly (manmade) fibers (staple fiber or continuous filament) made from synthetic polymers, also called synthetic fibers, made from polyester, polyamide, polyimide, aramid, polyolefin, polyacrylonitrile or glass, (manmade) fibers made from natural polymers such as cellulosic fibers (viscose, Modal, lyocell, Cupro, acetate, triacetate, Cellulon), such as rubber fibers, such as plant protein fibers and/or such as animal protein fibers and/or natural fibers made of cotton, sisal, flax, silk, hemp, linen, coconut or wool. The present invention, however, is not confined to the materials stated; it is instead possible, as evident to the skilled person without having to take an inventive step, to use a multiplicity of further fibers in order to produce the nonwoven web. Likewise suitable, furthermore, are yarns fabricated from the aforementioned fiber materials.

In the case of woven fabrics or scrims, individual threads may be produced from a blend yarn, and thus may have synthetic and natural constituents. Generally speaking, however, the warp threads and the weft threads are each formed of a single kind.

The warp threads and/or the weft threads here may in each case be composed only of synthetic threads or only of threads made from natural raw materials.

Preferred as material for the carrier is polyester, owing to the excellent aging resistance and the outstanding media resistance with respect to chemicals and service fluids such as oil, gasoline, antifreeze, and the like. Polyester has the advantages, moreover, that it leads to a highly abrasion-resistant and temperature-stable carrier, this being of particular importance for the specific end use for the bundling of cables in automobiles and, for example, in the engine compartment.

Also suitable for jacketing the elongate product is a carrier which consists of paper, of a laminate, of a film (for example PP, PE, PET, PA, PU), of foam or of a foamed film.

These non-textile sheetlike materials are especially appropriate when specific requirements necessitate such a modification of the invention. Films are generally thinner in comparison to textiles, for example, and, as a result of the imperforate layer, offer additional protection against penetration by chemicals and service fluids such as oil, gasoline, antifreeze and the like into the actual cable area, and can be substantially adapted to requirements by an appropriate selection of the material from which they are constructed: with polyurethanes or polyolefin copolymers, for example, flexible and elastic jackets can be produced; with polyester and polyamides, good abrasion resistance and temperature stability are achieved.

Foams or foamed films, on the other hand, possess the qualities of more substantial space filling and of good soundproofing—where a length of cable is laid, for example, in a duct-like or tunnel-like area in the vehicle, a jacketing tape of appropriate thickness and soundproofing can prevent disruptive flapping and vibration from the outset.

The adhesive tape may ultimately have a liner material, with which the one or two layers of adhesive are lined before use. Suitable liner materials also include all of the materials set out comprehensively above.

It is preferred to use a non-linting material such as a polymeric film or a well-sized, long-fiber paper.

If the adhesive tape described is to be of low flammability, this quality can be achieved by adding flame retardants to the carrier and/or to the adhesive. These retardants may be organobromine compounds, if required with synergists such as antimony trioxide, although, with regard to the absence of halogen from the adhesive tape, preference will be given to using red phosphorus, organophosphorus compounds, mineral compounds or intumescent compounds such as ammonium polyphosphate, alone or in conjunction with synergists.

The general expression “adhesive tape” in the context of this invention encompasses all sheetlike structures such as two-dimensionally extended sheets or sheet sections, tapes with extended length and limited width, tape sections and the like, and also, lastly, diecuts or labels.

The adhesive tape may be produced in the form of a roll, in other words rolled up onto itself in the form of an Archimedean spiral. Applied to the reverse of the adhesive tape may be a reverse-face varnish, in order to exert a favorable influence on the unwind properties of the adhesive tape wound into the Archimedean spiral. This reverse-face varnish may for this purpose be furnished with silicone compounds or fluorosilicone compounds and also with polyvinylstearylcarbamate, polyethyleneiminestearylcarbamide or organofluorine compounds as adhesive substances or for nonstick coating.

The adhesive may be applied in the longitudinal direction of the adhesive tape, in the form of a stripe, the width of the stripe being lower than that of the carrier of the adhesive tape.

Depending on the particular utility, there may also be a plurality of parallel stripes of the adhesive coated on the carrier material. The position of the stripe on the carrier is freely selectable, with preference being given to an arrangement directly at one of the edges of the carrier.

The adhesive is preferably applied over the full area to the carrier.

Provided on the adhesive coating of the carrier there may be at least one stripe of a covering, extending in the longitudinal direction of the adhesive tape and covering between 20% and 90% of the adhesive coating. The stripe preferably covers in total between 50% and 80% of the adhesive coating. The degree of coverage is selected according to the application and to the diameter of the cable loom. The percentage figures indicated relate to the width of the stripes of the covering in relation to the width of the carrier.

In accordance with one preferred embodiment of the invention there is precisely one stripe of the covering present on the adhesive coating.

The position of the stripe on the adhesive coating is freely selectable, with preference being given to an arrangement directly at one of the longitudinal edges of the carrier. In this way an adhesive stripe is produced which extends in the longitudinal direction of the adhesive tape and finishes at the other longitudinal edge of the carrier. Where the adhesive tape is used for jacketing a cable harness, by the adhesive tape being passed in a helicoidal movement around the cable harness, the wrapping of the cable harness may be accomplished by bonding the adhesive of the adhesive tape only to the adhesive tape itself, with the product not coming into contact with any adhesive. The cable harness jacketed in this way has a very high flexibility, as a result of the absence of fixing of the cable by any adhesive. Consequently the flexibility of said cable harness on installation—particularly in narrow passages or sharp bends—is significantly increased.

If a certain degree of fixing of the adhesive tape on the product is desired, the jacketing may be accomplished by bonding part of the adhesive stripe to the adhesive tape itself and another part to the product. In accordance with another advantageous embodiment, the stripe is applied centrally on the adhesive coating, thereby producing two adhesive stripes extending on the longitudinal edges of the carrier in the longitudinal direction of the adhesive tape.

For the secure and economic application of the adhesive tape in said helicoidal movement around the cable harness, and to counter the slipping of the resultant protective wrapping, the two adhesive stripes each present on the longitudinal edges of the adhesive tape are advantageous, especially if one stripe, which is usually narrower than the second stripe, serves as a fixing aid and the second, broader stripe serves as a fastener. In this way, the adhesive tape is bonded to the cable in such a way that the cable harness is secured against slipping but is nevertheless of flexible design. In addition there are embodiments in which more than one stripe of the covering is applied to the adhesive coating. Where reference is made only to one stripe, the skilled person reads this, conceptually, as accommodating the possibility that there may well be two or more stripes covering the adhesive coating at the same time.

Also a subject of the invention is a method for producing an adhesive tape and also an adhesive tape obtainable by this method, more particularly for the wrapping of cables, composed of a textile carrier and a pressure-sensitive adhesive applied to at least one side of the carrier, wherein the pressure-sensitive adhesive
is applied on at least one side of the textile carrier, and
optionally the pressure-sensitive adhesive is dried;
   the pressure-sensitive adhesive here comprising (i) a polymeric acrylate dispersion and (ii) modified phyllosilicates. According to one particularly preferred method variant, the pressure-sensitive adhesive comprises between 15 and 100 parts by weight of a tackifier (based on the mass of the dried polymeric dispersion).

According to preferred methods, the PSA comprises modified phyllosilicates, which are natural or synthetically produced three-layer phyllosilicates. Particular preference is given here to using swellable modified phyllosilicates, which more particularly are to be swellable in polar media, preferably in polar organic solvents, more preferably in water. Polar media contemplated are preferably water-miscible polar solvents, such as protic or aprotic solvents. These may be ketones such as acetone, ethyl acetate, alcohols such as ethanol, THF, or else polar monomers of the acrylates.

Likewise a subject of the invention is a method for producing an adhesive tape, more particularly for the wrapping of cables, composed of a textile carrier and a PSA applied on at least one side of the carrier, and also an adhesive tape obtainable by this method, wherein the PSA
is applied on at least one side of the textile carrier,
the pressure-sensitive adhesive is optionally dried,
the pressure-sensitive adhesive is crosslinked with electron beams,
   the carrier preferably being located on the PSA side facing away from the electron-beam source.

More particularly the electron beam crosslinking (EBC) takes place with 0.001 to 80 kGy, preferably with 5 to 80 kGy, more preferably with 10 to 50 kGy. Depending on PSA, crosslinking takes place with 5 to 20 kGy or alternatively with 20 to 50 kGy; with further preference, the PSA side facing away from the carrier material is irradiated with electron beams (EBC), the dose being more particularly 5 to 50 kGy, especially 5 to 45 kGy, 5 to 20 kGy depending on PSA, or alternatively 20 to 50 kGy, where the PSA comprises (i) a polymeric acrylate dispersion and (ii) modified phyllosilicates, the PSA further comprising between 15 and 100 parts by weight of a tackifier (based on the mass of the dried polymeric dispersion).

The procedure for producing the adhesive tape of the invention involves coating of the carrier directly with the PSA in one or more operations carried out in succession. In the case of textile carriers, the untreated textile can be coated directly or by a transfer process. Alternatively the textile may be pretreated with a coating or impregnation (using any desired film-forming substance from solution, dispersion, melt and/or radiation-curing), before then being provided, in a downstream workstep, directly or by a transfer process, with the PSA. Application assemblies used are the customary ones: wire doctor, coating bar, roll application, nozzle coating, twin-chamber doctor blade, multiple cascade nozzle.

In accordance with the invention, the PSA may additionally be crosslinked directly with electron beams, so that the PSA is not crosslinked with electron beams through the carrier side, but instead the electron beam source is directly facing the unlined PSA.

Preferred PSAs comprise in the overall composition in wt %:
(i) 24 to 89.9 wt % of an aqueous acrylate dispersion,
(ii) 10 to 75.9 wt % of a tackifier, and
(iii) 0.1 to 5 wt % of modified phyllosilicates, in the form of a solution or dispersion comprising modified phyllosilicates and having a defined modified phyllosilicate solids content, based on the overall composition of the pressure-sensitive adhesive.

Particular preference is given to
(i) 50 to 80 wt %, preferably 60 to 70 wt %, of an aqueous acrylate dispersion, preferably having a solids content of acrylates of 30 to 80 wt %, more particularly of 40 to 70 wt %, preferably of 50 to 60 wt %, more preferably of 55 wt %, with a fluctuation range of plus/minus 5 wt %, more particularly plus/minus 2.5 wt %,
(ii) 20 to 50 wt %, preferably 20 to 40 wt %, of a tackifier, and
(iii) 0.2 to 2.5 wt % of modified phyllosilicates, in the form of a solution or dispersion comprising modified phyllosilicates with defined solids content of modified phyllosilicates, preferably 0.7 to 2.0 wt % of modified phyllosilicates,
   based on the overall composition of the PSA.

According to one particularly preferred alternative, the modified phyllosilicates are added in the form of a solution or dispersion. In that case (iii) corresponds to 0.1 to 10 wt % of a solution of modified phyllosilicates, more particularly a solution or dispersion having a modified phyllosilicate content of around 25 wt %, particular preference being given to 0.5 to 7.5 wt %, 1.0 to 7.0 wt %, 2.0 to 7.0 wt %, 2.0 to 5.0 wt % of the solution or dispersion. Hence even very small amounts of phyllosilicates are sufficient for the construction of a barrier layer.

The solids content is based in each case, independently, on the mass of the dried polymeric dispersion or of the dried solution.

Likewise a subject of the invention is a sheetlike bonding agent comprising the PSA or adhesive, where the sheetlike bonding agent is selected from a sheetlike element of the adhesive and an adhesive tape, the adhesive tape having a carrier and, on at least one side of the carrier, the applied adhesive, more particularly PSA, and the adhesive of the sheetlike bonding agent is substantially dried.

Another subject of the invention is the use of modified phyllosilicates in PSAs for the purpose of adjusting the unwind force, in particular the unwind force of the PSAs comprising modified phyllosilicates that are applied on one side of a textile carrier being reduced in comparison to the unwind force of the corresponding PSAs without phyllosilicates that are applied on one side of a textile carrier, by greater than or equal to 10%, more particularly greater than or equal to 20%, preferably greater than or equal to 30%, more preferably greater than or equal to 40%, with preference greater than or equal to 50%.

A further subject of the invention is the use of modified phyllosilicates in PSAs or adhesive tapes for adjusting or improving the barrier properties of the PSA with respect to plasticizers, more particularly as a barrier layer for plasticizers, with particular preference as a barrier layer with respect to migration of plasticizers from PVC.

PSA or adhesive tapes of the invention are capable of reducing the migration of plasticizers from cable jacketing on an elongate product, and more particularly are capable of reducing the migration of plasticizer from an elongate product jacketed with PVC. As a result, the embrittlement of the cable insulation is suppressed and retarded over the long term.

A further subject of the invention is the use of electron beams for crosslinking PSAs of the invention on carriers of adhesive tapes, more particularly of adhesive tapes which are suitable for cable wrapping, more particularly the use for the wrapping of cables in the automotive segment such as cable harnesses in motor vehicles, and also, generally, of cables which are subject to particular influences such as heat and/or humidity, such as of cables which are installed in wind turbines, such as offshore wind parks, etc. Another subject of the invention, therefore, is the use of electron beam (EBC)-crosslinked adhesive tapes, adhesive tapes in accordance with the invention produced by the method of the invention, for the wrapping of cables, more particularly of cables which are subject to elevated temperature and/or humidity. On account of the positive properties described, the adhesive tape can be used outstandingly for the insulating and wrapping of wires or cables.

Another subject of the invention is the use of an adhesive tape of the invention comprising modified phyllosilicates, or of an adhesive tape produced in accordance with the invention, for the jacketing of elongate product, where the adhesive tape is passed in a helicoidal line around the elongate product or alternatively where the tape is wrapped around the elongate product in axial direction. Additionally a subject of the invention is an elongate product, such as a cable harness in particular, jacketed with an adhesive tape of the invention.

A subject of the invention is the use of the adhesive tapes of the invention for reducing the migration of plasticizers from cable sheathing such as cable jacketing and cable insulation or for retarding the embrittlement of cable sheathing, more particularly for reducing the migration of plasticizer from PVC-jacketed cables. The use in accordance with the invention allows the amount of plasticizers, in each case in wt %, in cable sheathing after at least 2000 hours to still be at least 60% of the original amount in the cable sheathing, in particular as measured under or in accordance with the conditions of LV 312.

The amount of plasticizers in PVC cable sheathing, particularly of the plasticizers comprising TOTM, DOP (dioctyl phthalate, di-2-ethylhexyl phthalate), DINP (diisononyl phthalate), TOTM (trioctyl trimellitate), DINP (diisodecyl phthalate), triethyl citrate or adipic acid-based plasticizers such as diethylhexyl adipate and diethyloctyl adipate, is preferably determined. With particular preference the amount of plasticizers in cable sheathing wrapped with the adhesive tapes of the invention after 2000 hours is greater than or equal to 66%, preferably greater than or equal to 70%, more preferably greater than or equal to 80%, it being further preferred if the amount after 2500 hours or after 3000 hours, in each case independently, still has at least an amount of 60% of the original amount of plasticizers. Preferred amounts are greater than or equal to 66%, 70%, 75%, 80% or 85%.

On account of the outstanding suitability of the adhesive tape, it can be used in a jacket that consists of a covering, where, at least in one edge region of the covering, the self-adhesive tape is present, and is bonded on the covering in such a way that the adhesive tape extends over one of the longitudinal edges of the covering, and preferably in an edge region which is narrow by comparison with the width of the covering. One such product and also optimized embodiments thereof are disclosed in EP 1 312 097 A1. EP 1 300 452 A2, DE 102 29 527 A1 and WO 2006 108 871 A1 show ongoing developments for which the adhesive tape of the invention is likewise very suitable. The adhesive tape of the invention may also find use in a method of the kind disclosed by EP 1 367 608 A2. Finally, EP 1 315 781 A1 and DE 103 29 994 A1 describe embodiments of adhesive tapes of a kind also possible for the adhesive tape of the invention.

With further preference the adhesive tape, in bonding to cables with PVC jacketing and to cables with polyolefin jacketing, does not destroy these systems when an assembly composed of cables and adhesive tape is, in accordance with LV 312, stored at temperatures above 100° C. for up to 3000 hours and then the cables are bent around a mandrel. The adhesive tape of the invention is outstandingly suitable for the wrapping of cables, can be easily unwound for simple processing, exhibits little or no flagging, and exhibits no cable embrittlement even in the high temperature classes C and D over 3000 hours.

The purpose of the text below is to provide a closer, exemplary illustration of the adhesive tape using a number of figures, without restricting the invention to those embodiments. The technical features disclosed in the examples may be generalized when looked at together with the above-stated features.

### BRIEF DESCRIPTION OF THE DRAWINGS

FIG. 1 shows the adhesive tape in a lateral section,

FIG. 2 shows a detail section of a cable harness which is composed of a bundle of individual cables and is jacketed with the adhesive tape of the invention, and

FIG. 3 shows an advantageous application of the adhesive tape,

FIGS. 4 to 7 show measurement of flagging resistance according to LV 312 or to TFT method,

FIG. 8 shows interaction of cohesion and adhesion during detachment of the tape end,

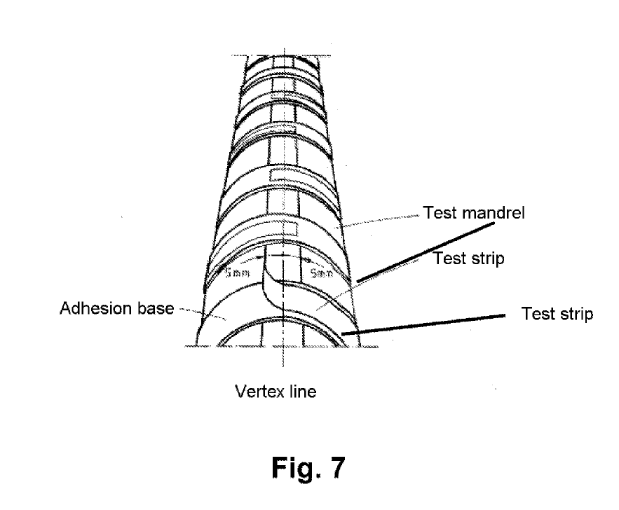

FIG. 9 shows mode of functioning of the barrier layer,

FIG. 10 shows a diagrammatic construction of a phyllosilicate crystal,

FIG. 11 shows shear stress sweep 25° C. viscosity,

FIG. 12 shows discoloration in the case of the PVC reference lead from Gebauer & Griller,

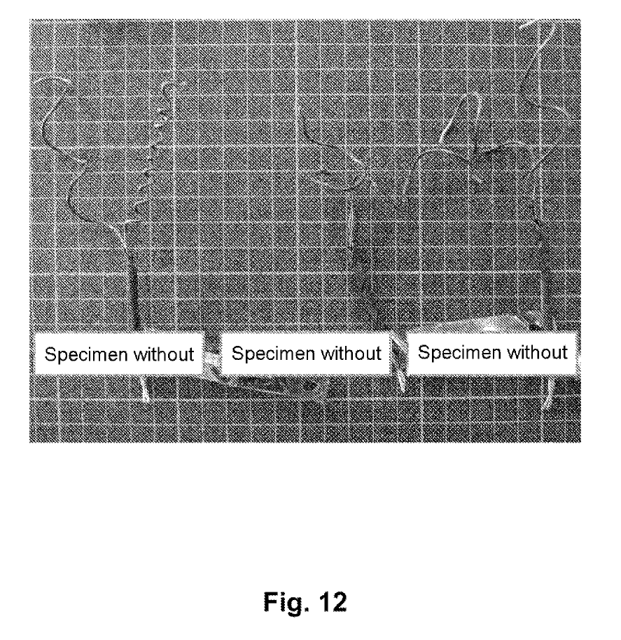

FIG. 13 shows undiscolored specimens (gleaming metallically).

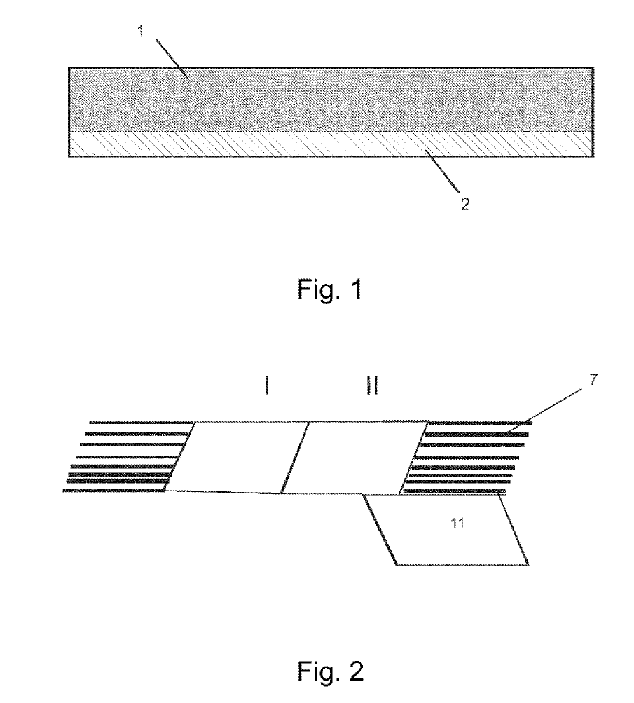

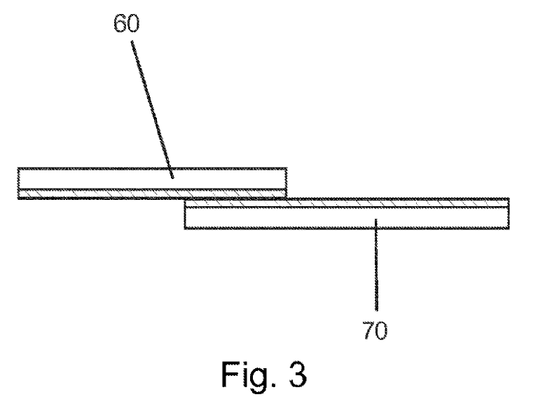

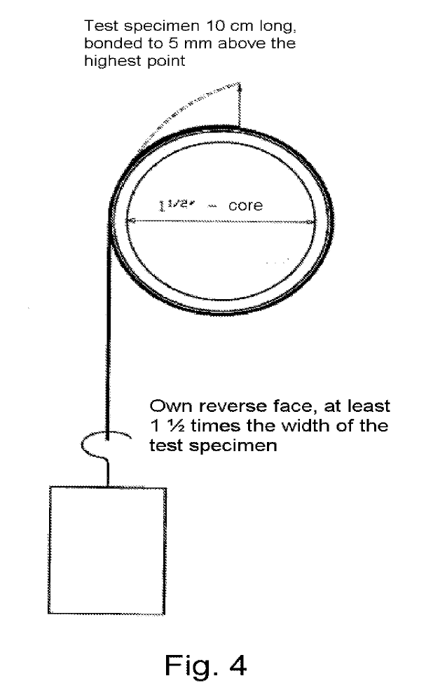

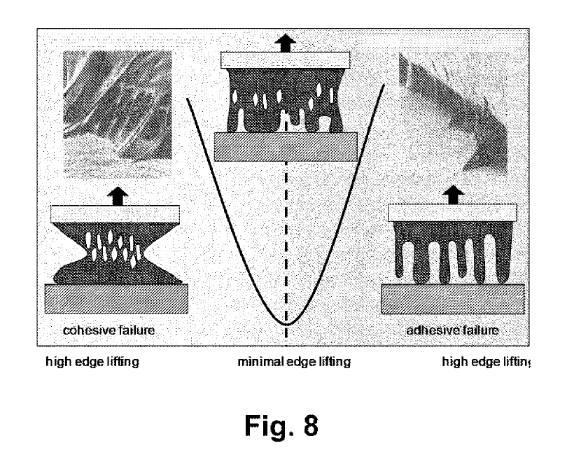

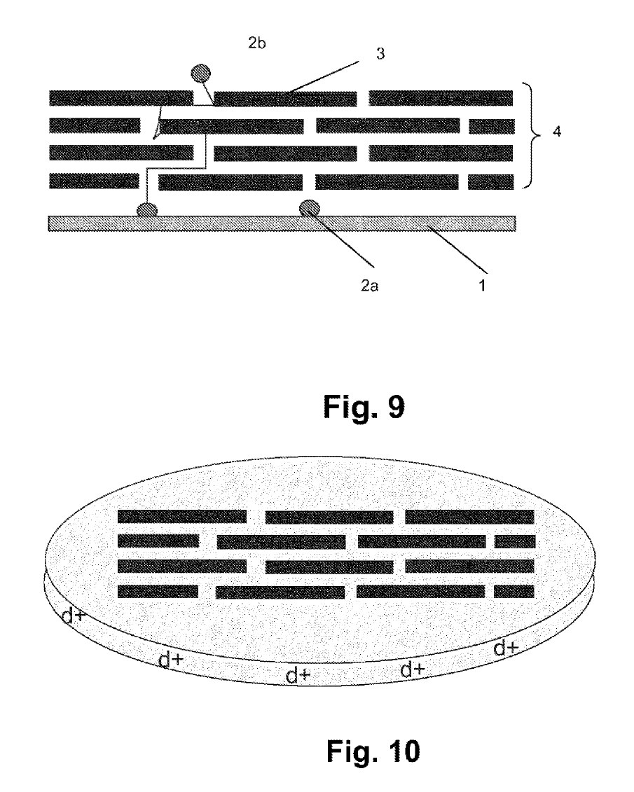

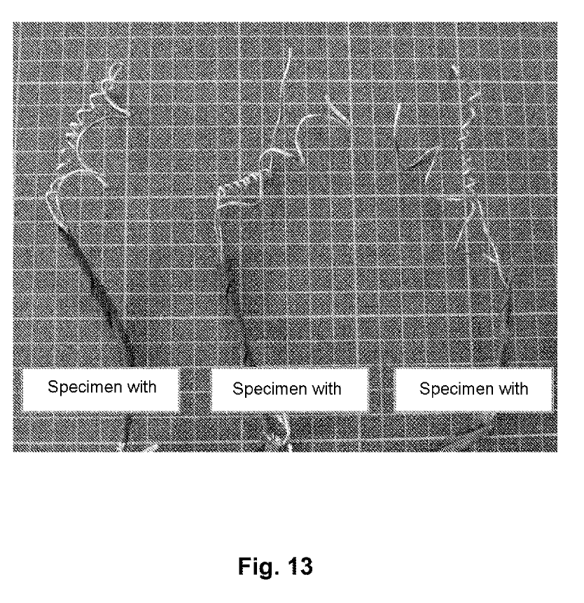

Shown in FIG. 1, in a section in the transverse direction (transverse section), is the adhesive tape, consisting of a woven fabric carrier 1, on one side of which a layer of a self-adhesive coating 2 is applied. FIG. 2 shows a cut-out section of a cable harness which is composed of a bundle of individual cables 7 and is jacketed with the adhesive tape 11 of the invention. The adhesive tape is passed in a helicoidal movement around the cable harness. The cable harness detail shown has two turns I and II of the adhesive tape. Further turns would extend toward the left, but are not shown here. In a further embodiment for jacketing, two tapes 60, 70 of the invention, furnished with an adhesive, are laminated with their adhesives at an offset (preferably by 50% in each case) to one another, producing a product as shown in FIG. 3. Shown diagrammatically in FIG. 9 is a barrier layer 4, which is composed of individual three-layer silicates 3 and which prevents migration of the plasticizer molecules 2a from the substrate 1, such as a cable insulation 1, to the outer surface of the adhesive tape, with the consequence that only small amounts of migrated plasticizer molecules 2b are present. FIG. 10 shows diagrammatically an individual Laptonite crystal having a diameter of around 25 nm and thickness of 0.92 nm. There are partial charges of the outer edges.

### EXAMPLES

Outline of the examples: The adhesive tape of the invention is described below in preferred embodiment by means of a number of examples, without wishing thereby to subject the invention to any restriction whatsoever. In addition, comparative examples are given, which show noninventive adhesive tapes.

To illustrate the invention, example adhesive tapes were produced according to the following scheme: The PSA dispersions were mixed from polymer dispersion and resin dispersion in line with the example formulas, and were intimately homogenized using a stirrer. The PSA dispersions were subsequently adjusted, by stirred incorporation of a modified phyllosilicate, to a viscosity of approximately 500 Pa*s at a shear rate of 0.1 s⁻¹

Using a film-drawing apparatus, a woven polyester fabric specified in the examples was coated with the thickened example PSA dispersion in such a way as to result, after drying in a forced-air oven at 85° C. for 5 minutes, in an adhesive coatweight of approximately 20 g/m². In a second work-step, the fabric impregnated in this way was coated analogously with the same dispersion, so as to result, after drying in a forced-air oven at 85° C. for 10 minutes, in a total adhesive coatweight of 90 g/m², respectively, as specified in the examples.

Assessment criteria: The criteria for an application-compatible adhesive tape for the wrapping of cables is presently the peel adhesion to steel, the peel adhesion to the reverse face in combination with the unwind force at 30 m/min. Unwind force of rolls after storage at room temperature, around 23° C., over 4 weeks, at 50% atmospheric humidity.

Test procedure: Unless expressly stated otherwise, the measurements are carried out under test conditions of 23±1° C. and 50±5% relative humidity.

### Measurement of Flagging Resistance to LV 312 or TFT Method (Threshold Flagging Time)

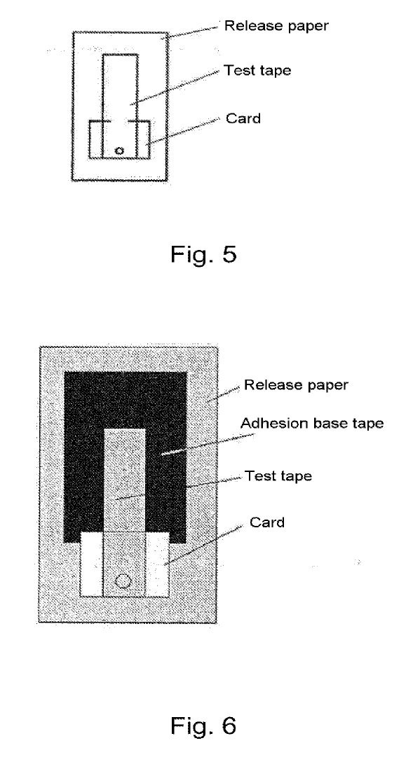

For determining the flagging behavior by the TFT method, a test is employed in which an additional flexural stress is generated by the application of the test specimens, prepared in a flat format, to a 1½″ core. The combination of tensile load by a test weight and flexural stress causes flagging-like detachment of the adhesive tape starting from the bonded upper end, and ultimate failure by dropping of the test specimens (see FIG. 4, which also shows the schematic construction). The time in minutes before dropping is the result. The critical parameters for the holding time of the test specimens are weight and temperature, the weight being selected such as to result in values of at least 100 minutes.

The cylindrically shaped test mandrel is a 1½″ card core with an external diameter of 42±2 mm, provided with a marking line 5 mm adjacent to the vertex line.

The adhesion base is the adhesive tape's own reverse face.

The manual roller has a weight of 2 kg.

The test weight is 1 kg.

The test conditions are 23±1° C. and 50±5% relative humidity, or 40° C. in the heating cabinet.

The test is carried out on strips of adhesive tape 19 mm wide. A strip with a length of 400 mm is adhered to release paper and cut to form three strips with a length of 100 mm each. This should be done using a fresh cutter blade. The reverse face must not be touched. A small piece of card is adhered beneath one of the ends of each strip, and the assembly is perforated (see FIG. 5). The test strips are then individually bonded centrally to strips of the broader adhesion base (adhesive tape with a width 1% times that of the adhesive tape under test), so that the small piece of card still overlaps just (2 to 3 mm) at the end (see FIG. 6). The test specimens are rolled down using the 2 kg manual roller at a rate of 10 m/min in 3 cycles. The finished test samples, in other words the test strips together with adhesion base, are then adhered to the card core in such a way that the upper end of the test specimen overlaps the vertex point by 5 mm (see FIG. 7). In this operation, only the adhesion base, and not the test specimen, must be pressed on. The test specimens fully prepared are left for 20±4 hours without weight loading in a controlled-climate chamber at 40° C.

Weights with a mass of one kilogram are then hung onto the specimens, and the stopwatches are started. The measurement ends after failure of all three test specimens of one sample. The median of the three individual measurements is reported in minutes. The holding time is reported in minutes. In this context, a TFT value of greater than or equal to 700 minutes, preferably greater than or equal to 1000 minutes, more preferably greater than or equal to 1200 minutes, very preferably greater than or equal to 2000 minutes is considered to be a lower limit with regard to resistance to flagging.

### Unwind Force

Measurement of the unwind force to LV 312 with a haul-off speed of 30 m/min.

### Softening Point

Measurement according to ASTM E28-99 (2009)

### Plasticizer Extraction

0.5 to 1 g of a comminuted sample is extracted with 20 to 100 ml of toluene (n-toluene) in an ultrasound bath at 60° C. for 60 minutes. The amount of plasticizer is determined by GC-MS. Using this method it is possible to detect plasticizer contents of 5 mg/kg.

### Thermal Aging

LV 312-1 (in particular from page 10 onward).

### Rheology

Experimental details: instrument: Rheometer DSR 200 N from Rheometric Scientific,
measuring head: 200 g air-mounted with normal force,
measuring geometry: plate/cone,
heating: Peltier elements with regulation and primary cooling,
diameter: 25 mm (cone), cone angle: 0.1 rad., gap: 0.053 mm, shear stress sweep (cone),
temperature: 25° C.,
initial shear stress: 0.1 Pa, final shear stress: 4790 Pa,
points per decade: 10
shear rate of 100 s⁻¹

### Gel Value

The gel value is determined by Soxhlet extraction, which extracts soluble constituents from polymers in a continuous extraction. In the case of determination of the gel value of (aqueous) polyacrylate PSAs, a suitable solvent such as tetrahydrofuran, for example, extracts the soluble fractions of a polymer—the so-called sol—from the insoluble fractions—the so-called gel. Preparation: the material for extraction is applied in a thin film—film thickness generally 120 μm—to siliconized release paper and dried at 80° C. for around 12 hours (forced-air drying cabinet). The films are stored in a desiccator over drying agent. The Whatman 603 extraction sleeves are dried at 80° C. for 12 h, the empty weight of the sleeves is determined, and they are stored in a desiccator before being used.

### Gel Value Determination

Around 1 g of PSA is weighed out into an extraction sleeve. A 100 ml round-bottomed flask of the Soxhlet apparatus is filled with 60 ml of tetrahydrofuran and heated to boiling. THF vapors ascend through the vapor tube of the Soxhlet apparatus and condense in the condenser, and THF drips into the extraction sleeve and extracts sol fraction. In the course of the extraction, the THF I runs back into the flask with the extracted sol. Dissolved sol accumulates in the flask increasingly. After 72 hours of continuous extraction, the sol is completely dissolved in the THF. Then, after the apparatus has been cooled to room temperature, the extraction sleeve is withdrawn and is dried at 80° C. for 12 hours. The sleeves are stored in a desiccator to constant mass and then weighed. The gel value of the polymer is calculated using the following formula:

$$Gel value = \frac{{m}_{3} - {m}_{1}}{{m}_{2} - {m}_{1}} \cdot 100 \%$$

where
m₁: mass of extraction sleeve, empty
m₂: mass of extraction sleeve+polymer
m₃: mass of extraction sleeve+gel

### Measurement of Peel Adhesion

For measuring the peel adhesion of the pure dispersions, coated-out samples of the adhesives were prepared first of all. For this purpose, the dispersions were applied to a PET film (polyethylene terephthalate) with a thickness of 23 μm, and were drawn down using a film-drawing apparatus in such a way as to result, after drying for 5 minutes at 105° C. in a forced-air drying cabinet, in an adhesive coatweight of 30 g/m².

Using a cutter knife, strips 20 mm wide and 25 cm long were cut from this sheet. For measuring the peel adhesion of the formulations with resin, coated-out samples were drawn down as described above onto woven polyester fabrics, and likewise cut using a cutter knife into strips 20 mm wide and 25 cm long. The peel adhesion to steel of the specimens was measured to ASTM D3330. The peel adhesion to the reverse face was measured according to ASTM D3330.

### Flexural Stiffness

The flexural stiffness is determined using a KWS basic 2000 mN Softometer (from Wolf Messtechnik GmbH). (MD) stands for machine direction, meaning that the flexural stiffness is determined in machine direction.

### Composition of an Inventive Polymer Dispersion:

| Monomer | Polymer A |
|---|---|
| 2-Ethylhexyl acrylate | 93 |
| Butyl acrylate | |
| Acrylic acid | 4 |
| Acrylonitrile | 3 |
| Methyl methacrylate | — |
| Vinyl acetate | — |

The glass transition temperature of polymer A: −47° C.

The PSAs listed in table 1 were formulated from the polymer A by blending with tackifier resin dispersions. The number here indicates the parts by weight of tackifier per 100 parts by weight of polymer A (based in each case on solids).

TABLE 1
PSA comprising polymer

| | | Polymer A |
|---|---|---|
| | Softening point | 100 parts polymer A |
| Tackifier type | ° C. | to 45 parts resin |
| Snowtack 100 G rosin | 99 | 30 wt % |
| ester resin, Lawter | | |

The glass transition temperature of the pressure-sensitive adhesive formulation was determined as the dynamic Tg by means of rheological analysis (temperature sweep) at 7 to 8° C.

### Example 1

Carrier: woven PET, 130 g/m²
Warp: 48 threads/cm×167 dtex
Weft: 24 threads/cm×167 dtex

PSA: resin-modified acrylate dispersion, 90 g/m²
(polymer A with 30% rosin ester resin)
+addition of:
1.1 2.5 wt % (liquid on liquid) of a solution of a synthetic phyllosilicate with 25 wt % solids content (Laponite SL 25, from Rockwood). This corresponds to 1.1 wt % (solid on solid) for a solids concentration of the acrylate dispersion of 57.4 wt %.
1.2 5.0 wt % (liquid on liquid) of a solution of a synthetic phyllosilicate with 25 wt % solids content (Laponite SL 25, from Rockwood). This corresponds to 2.2 wt % (solid on solid) for a solids concentration of the acrylate dispersion of 56.54 wt %.
1.3 7.0 wt % (liquid on liquid) of a solution of a synthetic phyllosilicate with 25 wt % solids content (Laponite SL 25, from Rockwood). This corresponds to 3.2 wt % (solid on solid) for a solids concentration of the acrylate dispersion of 55.9 wt %.

### Comparative Example 1

Carrier: woven PET, 130 g/m²
Warp: 48 threads/cm×167 dtex
Weft: 24 threads/cm×167 dtex

PSA: resin-modified acrylate dispersion, 90 g/m²
(polymer A with 30 wt % rosin ester resin)

### Comparative Example 2

Carrier: woven PET, 130 g/m²
Warp: 48 threads/cm×167 dtex
Weft: 24 threads/cm×167 dtex

PSA: resin-modified acrylate dispersion, 90 g/m²
(polymer A with 30 wt % rosin ester resin)
+addition of:

CP 1.1 5 wt % (solid on solid) of a fine kaolin grade
(Amazon Premium SD, from Cadam)

CP 1.2 15 wt % (solid on solid) of a fine kaolin grade
(Amazon Premium SD, from Cadam)

CP 1.3 25 wt % (solid on solid) of a fine kaolin grade
(Amazon Premium SD, from Cadam)

### Comparative Example 3

Carrier: woven PET, 130 g/m²
Warp: 48 threads/cm×167 dtex
Weft: 24 threads/cm×167 dtex

PSA: Acrylate hotmelt, 90 g/m²
UV dose: 25 mJ/cm²

TABLE 1
Peel adhesion, unwind force and TFT

| | | Peel | Peel | | |
|---|---|---|---|---|---|
| | | adhesion | adhesion | Unwind | |
| | | to steel | to reverse | force at | TFT** |
| | | Method | face Method | 30 m/min* | Method |
| | Addition | ASTM | ASTM | Method | (see |
| | of | D3330 | D3330 | LV 312 | above) |
| | filler | N/cm | N/cm | N/cm | min |
| Values for | 2.5 wt % | 5.9 | 4.1 | 3.8 | 1096 |
| example 1 | Laponite | | | | |
| | SL 25 | | | | |
| | (liquid on | | | | |
| | liquid) | | | | |
| | 5.0 wt % | 5.3 | 3.4 | 2.5 | 755 |
| | Laponite | | | | |
| | SL 25 | | | | |
| | (liquid on | | | | |
| | liquid) | | | | |
| | 7.0 wt % | 4.1 | 1.7 | 1.7 | 507 |
| | Laponite | | | | |
| | SL 25 | | | | |
| | (liquid on | | | | |
| | liquid) | | | | |
| Values for | — | 5.8 | 4.5 | 6.9 | 1234 |
| comparative | | | | | |
| example 1 | | | | | |
| Values for | 5.0 wt % | 4.5 | 6.9 | 6.2 | |
| comparative | Amazon | | | | |
| example 2 | Premium | | | | |
| | SD | | | | |
| | (solid on | | | | |
| | solid) | | | | |
| | 15.0 wt % | 4.5 | 6.9 | 5.6 | 522 |
| | Amazon | | | | |
| | Premium | | | | |
| | SD | | | | |
| | (solid on | | | | |
| | solid) | | | | |
| | 25.0 wt % | 4.5 | 6.9 | 4.5 | |
| | Amazon | | | | |
| | Premium | | | | |
| | SD | | | | |
| | (solid on | | | | |
| | solid) | | | | |
| Values for | — | 5.5 | 6.5 | 5.8 | 207 |
| comparative | | | | | |
| example 3 | | | | | |

*all rolls were slit at identical tension
**TFT = TFT value (Threshold Flagging Time)

The series of experiments for example 1 shows forcefully how the addition of an organically modified phyllosilicate may affect the unwind forces of a pressure-sensitive adhesive tape. The addition of just 2.5 wt % (liquid on liquid) to the adhesive, with experimental parameters otherwise the same, results in a design of adhesive which, in contrast to the original, unfilled adhesive (comparative example 1), experiences a reduction in unwind force of around 3 N/cm, corresponding to a percentage decrease of approximately 45%.

The peel adhesion to steel and to the tape's own fabric reverse face, in contrast, do not experience any significant change.

Applied to a cable loom, a modified adhesive design of this kind does not exhibit any weaknesses in terms of the standing-up of tape ends (flagging).

By adding larger amounts of the phyllosilicate, the unwind force can be reduced further. At an amount of 5 wt % (liquid on liquid), the unwind force is already around 36% of the original figure. Up to this point, the peel adhesion to smooth surfaces (see PA steel) shows no significant drop. With the rough surface of the fabric reverse face, the slightly reduced flowability of the adhesive is manifested noticeably. The result is a decrease in the peel adhesion to reverse face of around 1 N/cm in comparison to the unfilled adhesive.

From this point in time on, under high tensile and flexural stresses in the application, slight flagging may occur. Through the use of soft carrier materials, which exhibit only a slight tendency toward resilience, however, it is still possible to realize flagging-free products with this kind of design of adhesive.

At quantities above 5 wt %, a “physical overcrosslinking” can be observed. The effects on the peel adhesions are now significant here, with the peel adhesion to the reverse face decreasing by more than 60%. The already low level of unwind force can hardly be reduced further, and so such quantities ought not to be used.

Comparative example 2 serves for comparison with a common filler based on kaolin. This is a decidedly fine kaolin grade having an average particle size of <2 μm for the maximum diameter (at least 97%<2 μm).

In contrast to the highly soluble organic modified phyllosilicate based on smectite, the kaolin is not dispersed as thoroughly within the adhesive, and so is present more as an alien body in the form of unincorporated phases in the adhesive. As a result, it is not possible for a three-dimensional network to form on the basis of physical bonds between polymer chains and filler particles. Consequently, even when added at high levels of 25 wt % (solid on solid) to the adhesive, a comparatively small decrease in the unwind force is observed. Conversely, there is a massive detriment to the (instantaneous) peel adhesion to rough substrates, since the coarse particles very largely prevent rapid flow-on when the adhesive tape is pressed on. The peel adhesion to reverse face reduces accordingly, when 25 wt % of kaolin is added, to a value of around 40% of the original value. In such a case, the effects on the flagging behavior are dramatic, since the adhesive tape stands up at the ends just a short time after application, in order to be able to compensate the tensile and flexural strains which occur in the course of bonding.

Comparative example 3 serves for comparison with the technical adhesive data for a standard commercial fabric-backed adhesive tape with an acrylate hotmelt coating.

The effect on plasticizer migration was carried out with the adhesive design and the carrier of example 1:
Carrier: PET woven 130 g/m²
PSA: resin-modified acrylate dispersion, 90 g/m²
(polymer A with 30% rosin ester resin)
Addition of
5.0 wt % (liquid on liquid) of a solution of a synthetic phyllosilicate with
25 wt % solids content
(Laponite SL 25, from Rockwood)
corresponding to about 2.2 wt % solid on solid (the solids content of the completed dispersion adhesive/PSA is 56.5 wt %)

Serving as a comparative example is comparative example 1, which is identical in construction to example 1 but without Laponite SL 25.
Carrier: PET woven 130 g/m²
PSA: resin-modified acrylate dispersion, 90 g/m²
(polymer A with 30 wt % rosin ester resin)

TABLE 2
plasticizer content in weight percent based on lead (cable +
insulation); PVC Gebauer & Griller, type 67218

| | | Comparative | Example 1 |
|---|---|---|---|
| | | example 1 adhesive | adhesive tape with |
| | unbonded | tape without Laponite | Laponite SL25 |
| unaged | 21.4 | | |
| 2000 h | 19.8 | 12.9 | 18.1 |
| 2500 h | 18.8 | 11.6 | 16.7 |
| 3000 h | 17.4 | 10.0 | 14.2 |

To illustrate the invention, example adhesive tapes were produced according to the following scheme: the PSA dispersions were mixed from polymer dispersion and resin dispersion in accordance with the example formulas, and were intimately homogenized using a stirrer. The PSA dispersions were then adjusted to a viscosity of around 500 Pa*s at a shear rate of 0.01 s⁻¹ by stirred incorporation of an associative polyurethane thickener (Borchigel 0625, OMG Borchers). Using a film-drawing apparatus, a woven polyester fabric (as specified in the examples) was coated with the thickened example PSA dispersion so that drying in a forced-air oven at 85° C. for 5 minutes resulted in an adhesive coatweight of around 20 g/m². The woven fabric impregnated in this way was coated analogously with the same dispersion, in a second workstep, so that drying in a forced-air oven at 85° C. for 10 minutes resulted in an overall adhesive coatweight of 60, 70 or 90 g/m², respectively, in accordance with the information in the examples.

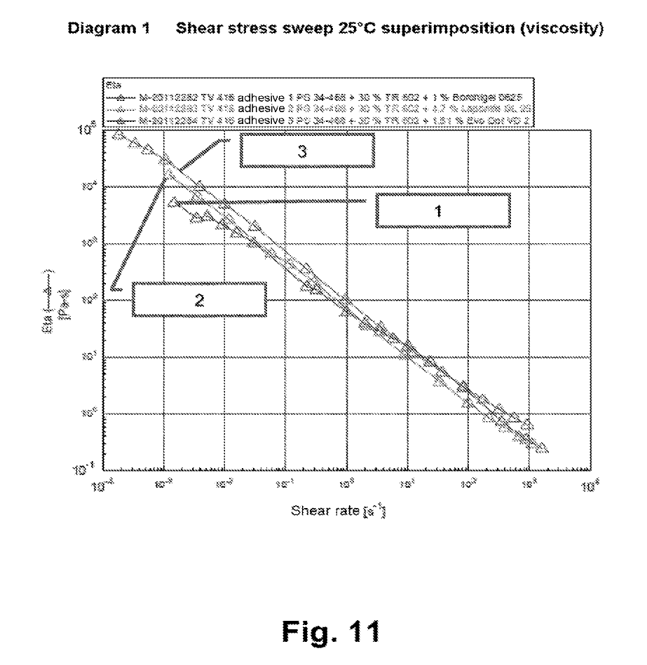

TABLE 3
samples SL 25 (Laptonite) - determination of viscosity
(flow curve) at 25° C. - for rheology see FIG. 11:
Sample designation

TV 416 adhesive 1 PS 34-468 + 30 wt % TR 602 + 1 wt %
Borchigel 0625
TV 416 adhesive 2 PS 34-468 + 30 wt % TR 602 + 4.7 wt %
SL 25
TV 416 adhesive 3 PS 34-468 + 30 wt % TR 602 + 1.51 wt %
Evo Dot VD 2

Procedure: shear stress sweep (flow curve) at 25° C. with a plate/cone measuring system, 1^{st} shear stress sweep 25° C., during shear stress sweep (FIG. 11) the viscosity of the samples was imaged. The values for the viscosity at 2 shear rates are evident from table 4.

TABLE 4

| Sample designation | Viscosity 0.1 s⁻¹ | | Viscosity 1000 s⁻¹ |
|---|---|---|---|
| TV 416 adhesive 1 PS 34-468 + | 525 | Pa s | 0.61 Pa s |
| 30 wt % TR 602 + 1 wt % | | | |
| Borchigel 0625 (designation | | | |
| “1” in FIG. 11) | | | |
| TV 416 adhesive 2 PS 34-468 + | 485 | Pa s | 0.33 Pa s |
| 30 wt % TR 602 + 4.7 wt % | | | |
| SL 25 (designation | | | |
| “2” in FIG. 11) | | | |
| TV 416 adhesive 3 PS 34-468 + | 1030 | Pa s | 0.34 Pa s |
| 30 wt % TR 602 + 1.51 wt % | | | |
| Evo Dot VD 2 (designation | | | |
| “3” in FIG. 11) | | | |

### Summary and Outlook:

The samples show the typical behavior of a thickened dispersion adhesive with properties of structural viscosity.

LV 312 test: testing for cable compatibility

For all temperature classes B, C, D

Test result matrix: assess test specimens

Take lead harness from the oven, assess (A), wrap around 20 mm mandrel, assess (W, K, R, V)J carrying out kV testing, assess (HS), untape (ET, FL, FT, E, TS), wrap around 2 mm, assess (WKR) wrap around 10 mm mandrel, assess (WKRV)

Evaluation tables 5a, 5b, 5c:

Test passed without failure: 1

Test passed: tape no longer tacks TS

Test failed: 0

A: after storage, HS: kV test negative, R: tears in adhesive tape, W: lead unsatisfactory after winding around the mandrel; K: cable loom flattened; TS: adhesive tape no longer tacks; FL: insulation color no longer apparent; FT: discoloration of adhesive tape (brown), ET: lead unsatisfactory on removal of the adhesive tape; V: shift in position of cable tape; E: lead unsatisfactory on untwisting.

### Comparative Example 1, Without Laponite:

Adhesive tape designation: tested temperature class: T2

TABLE 5a
Test group 1
Long-term thermal aging

| | Storage period | | | | | | | | | | | | | | | | | |
|---|---|---|---|---|---|---|---|---|---|---|---|---|---|---|---|---|---|---|
| | 500 h | | | 1000 h | | | 1500 h | | | 2000 h | | | 2500 h | | | 3336 h | | |
| Mandrel | 20 | 10 | 2 | 20 | 10 | 2 | 20 | 10 | 2 | 20 | 10 | 2 | 20 | 10 | 2 | 20 | 10 | 2 |
| diameter | | | | | | | | | | | | | | | | | | |
| in mm | | | | | | | | | | | | | | | | | | |

Lead test group 1e (PVC, G&G) T = 105° C.

| | | | | | | | | | | | | | | | | | | |
|---|---|---|---|---|---|---|---|---|---|---|---|---|---|---|---|---|---|---|
| With | 1 | 1 | 1 | 1 | 1 | 1 | 1 | 1 | 1 | 1 | 1 | 0/w | 1 | 0/w | 0/w | 1 | 0/w | 0/w |
| adhesive | | | | | | | | | | | | | | | | | | |
| tape | | | | | | | | | | | | | | | | | | |

Lead test group 1e (PVC, Coroplast) T = 105° C.

| | | | | | | | | | | | | | | | | | | |
|---|---|---|---|---|---|---|---|---|---|---|---|---|---|---|---|---|---|---|
| With | 1 | 1 | 1 | 1 | 1 | 1 | 1 | 1 | 0/w | 1 | 0/w | 0/w | 1 | 0/w | 0/w | 1 | 0/w | 0/w |
| adhesive | | | | | | | | | | | | | | | | | | |
| tape | | | | | | | | | | | | | | | | | | |

Example 1, with 5 wt % Laponite:

Adhesive tape designation: tested temperature class: T2

TABLE 5b
Test group 1
Long-term thermal aging

| | Storage period | | | | | | | | | | | | | | | | | |
|---|---|---|---|---|---|---|---|---|---|---|---|---|---|---|---|---|---|---|
| | 500 h | | | 1000 h | | | 1500 h | | | 2000 h | | | 2500 h | | | 3336 h | | |
| Mandrel | 20 | 10 | 2 | 20 | 10 | 2 | 20 | 10 | 2 | 20 | 10 | 2 | 20 | 10 | 2 | 20 | 10 | 2 |
| diameter in | | | | | | | | | | | | | | | | | | |
| mm | | | | | | | | | | | | | | | | | | |

Lead test group 1e (PVC, G&G) T = 105° C.

| | | | | | | | | | | | | | | | | | | |
|---|---|---|---|---|---|---|---|---|---|---|---|---|---|---|---|---|---|---|
| With adhesive | 1 | 1 | 1 | 1 | 1 | 1 | 1 | 1 | 1 | 1 | 1 | 1 | 1 | 1 | 1 | 1 | 1 | 0/w |
| tape | | | | | | | | | | | | | | | | | | |

Lead test group 1e (PVC, Coroplast) T = 105° C.

| | | | | | | | | | | | | | | | | | | |
|---|---|---|---|---|---|---|---|---|---|---|---|---|---|---|---|---|---|---|
| With adhesive | 1 | 1 | 1 | 1 | 1 | 1 | 1 | 1 | 1 | 1 | 1 | 1 | 1 | 1 | 1 | 1 | 1 | 0/w |
| tape | | | | | | | | | | | | | | | | | | |

Reference specimen without tape:

Adhesive tape designation: tested temperature class: T2

TABLE 5c
Test group 1
Long-term thermal aging

| | Storage period | | | | | | | | | | | | | | | | | |
|---|---|---|---|---|---|---|---|---|---|---|---|---|---|---|---|---|---|---|
| | 500 h | | | 1000 h | | | 1500 h | | | 2000 h | | | 2500 h | | | 3336 h | | |
| Mandrel | 20 | 10 | 2 | 20 | 10 | 2 | 20 | 10 | 2 | 20 | 10 | 2 | 20 | 10 | 2 | 20 | 10 | 2 |
| diameter in | | | | | | | | | | | | | | | | | | |
| mm | | | | | | | | | | | | | | | | | | |

Lead test group 1e (PVC, G&G) T = 105° C.

| | | | | | | | | | | | | | | | | | | |
|---|---|---|---|---|---|---|---|---|---|---|---|---|---|---|---|---|---|---|
| With adhesive | 1 | 1 | 1 | 1 | 1 | 1 | 1 | 1 | 1 | 1 | 1 | 1 | 1 | 1 | 1 | 1 | 1 | 1 |
| tape | | | | | | | | | | | | | | | | | | |

Lead test group 1e (PVC, Coroplast) T = 105° C.

| | | | | | | | | | | | | | | | | | | |
|---|---|---|---|---|---|---|---|---|---|---|---|---|---|---|---|---|---|---|
| With adhesive | 1 | 1 | 1 | 1 | 1 | 1 | 1 | 1 | 1 | 1 | 1 | 1 | 1 | 1 | 1 | 1 | 1 | 1 |
| tape | | | | | | | | | | | | | | | | | | |

### Determination of Plasticizer Content:

Extraction of the plasticizers with n-toluene in an ultrasound bath for quantitative determination
Determination of the plasticizers by GC-MS
Determination limit 5 mg/kg

1. A pressure-sensitive adhesive comprising an acrylate dispersion, wherein the acrylate dispersion comprises
(i) an aqueous polymeric acrylate dispersion, comprising polymers constructed of a) monomeric acrylates and optionally b) ethylenically unsaturated comonomers which are not acrylates, and
(ii) modified phyllosilicates.

2. The pressure-sensitive adhesive as claimed in claim 1,
wherein
the pressure-sensitive adhesive comprises
(I) 24 to 89.9 wt % of the aqueous acrylate dispersion,
(II) 10 to 75.9 wt % of a tackifier, and
(III) 0.1 to 5 wt % of modified phyllosilicates, in the form of a solution or dispersion comprising modified phyllosilicates and having a defined modified phyllosilicate solids content, in each case based on the overall composition of the pressure-sensitive adhesive.

3. The pressure-sensitive adhesive as claimed in claim 1,
wherein
the pressure-sensitive adhesive comprises an aqueous acrylate dispersion having a solids content of 50 to 60 wt % based on the aqueous acrylate dispersion.

4. The pressure-sensitive adhesive as claimed in claim 1, wherein
the acrylate dispersion has a gel value of greater than or equal to 40%, determined by means of Soxhlet extraction.

5. The pressure-sensitive adhesive as claimed in claim 1, wherein
the pressure-sensitive adhesive comprises a dried acrylate dispersion and is electrically conductive and/or antistatic, the pressure-sensitive adhesive being more particularly an electrically conductive and/or antistatic coating.

6. The pressure-sensitive adhesive as claimed in claim 1, wherein
the pressure-sensitive adhesive is a dried acrylate dispersion and comprises between 15 and 100 parts by weight of a tackifier, based on the mass of the dried polymeric dispersion.

7. The pressure-sensitive adhesive as claimed in claim 1, wherein
the acrylate dispersion comprises polymers constructed of
a) greater than or equal to 40 wt % of monomeric acrylates and
b) 0 to 60 wt % of ethylenically unsaturated comonomers,
where the monomeric acrylates comprise mono-, di- and/or polyfunctional acrylates and where the ethylenically unsaturated comonomers are selected from the group consisting of ethylene-containing monomers, vinyl-functional monomers, and unsaturated hydrocarbons having 3 to 8 C atoms.

8. The pressure-sensitive adhesive as claimed in claim 1, wherein
the acrylate dispersion comprises polymers constructed of
(I)a) monomeric acrylates selected from the group consisting of 40 to 90 wt % of n-butyl acrylate, 2-ethylhexyl acrylate and/or ethyl acrylate and 0 to 2 wt % of a di- or polyfunctional monomer,
b) ethylenically unsaturated comonomers at 10 to 60 wt %, selected from the group consisting of at least one ethylenically unsaturated monofunctional monomer or a mixture thereof and 0 to 10 wt % of an ethylenically unsaturated monomer having an acid or acid-anhydride function, or
(II)a) monomeric acrylates selected from the group consisting of 90 to 99 wt % of n-butyl acrylate and/or 2-ethylhexyl acrylate and 0 to 2 wt % of a di- or polyfunctional monomer,
b) ethylenically unsaturated comonomers at 10 to 1 wt %, selected from the group consisting of at least one ethylenically unsaturated monofunctional monomer or a mixture thereof and 0 to 10 wt % of an ethylenically unsaturated monomer having an acid or acid-anhydride function,
or
(III)a) monomeric acrylates selected from the group consisting of 30 to 75 wt % of alkyl acrylic esters having C₄ to C₁₂ alkyl radicals,
b) ethylenically unsaturated comonomers at 5 to 25 wt % of ethylene, 20 to 55 wt % of vinyl acetate, and 0 to 10 wt % of other ethylenically unsaturated compounds;
where the acrylate dispersion is prepared by reacting the monomers as per I, II and/or III in an emulsion polymerization.

9. The pressure-sensitive adhesive as claimed in claim 1, wherein the modified phyllosilicates are natural or synthetically produced three-layer phyllosilicates.

10. The pressure-sensitive adhesive as claimed in claim 1, wherein
the modified phyllosilicates are swellable.

11. The pressure-sensitive adhesive as claimed in claim 1, wherein the modified phyllosilicates are surface-modified with polar organic compounds, the surface modification taking place substantially via polar and/or ionic interactions.

12. The pressure-sensitive adhesive as claimed in claim 1, wherein
the modified phyllosilicates have a surface area of 50 m²/g to 1000 m²/g.

13. The pressure-sensitive adhesive as claimed in wherein
the diameter of the phyllosilicates is from 10 to 1000 nm at a height of about 1 nm.

14. An adhesive tape for wrapping cables, comprising a textile carrier and a pressure-sensitive adhesive as claimed in claim 1, applied on at least one side of the carrier and comprising
(i) a dried polymeric acrylate dispersion comprising polymers constructed of
a) monomeric acrylates and optionally
b) ethylenically unsaturated comonomers which are not acrylates, and
(ii) modified phyllosilicates,
where the pressure-sensitive adhesive comprises between 15 and 100 parts by weight of a tackifier (based on the mass of the dried polymeric dispersion).

15. The adhesive tape as claimed in claim 14, wherein
the pressure-sensitive adhesive applied on at least one side of the carrier comprises an electron beam (EBC)-crosslinked polymeric acrylate dispersion.

16. The adhesive tape as claimed in claim 14, wherein
the pressure-sensitive adhesive has an ASTM D3330 peel adhesion to steel of at least 4.5 N/cm (for a pressure-sensitive adhesive coatweight of 90 g/m² on woven polyester fabric carrier) and/or
the pressure-sensitive adhesive has an LV 312 unwind force of less than or equal to 4.0 N/cm at 30 m/min and/or
the pressure-sensitive adhesive has an ASTM D3330 peel adhesion to the reverse of the adhesive-tape carrier of at least 3.0 N/cm (for a pressure-sensitive adhesive coatweight of less than or equal to 90 g/m² on woven polyester fabric carrier).

17. The adhesive tape as claimed in claim 14, wherein the TFT (Threshold Flagging Time) is greater than or equal to 700 minutes.

18. A method for wrapping cables which are subject to elevated temperature and/or humidity, wherein said cables are wrapped with the adhesive tape of claim 14.

19. A method for reducing the migration of plasticizers from cable sheathing or for delaying the embrittlement of cable sheathing, which comprises forming said sheathing with the adhesive tape of claim 14.

20. The method of claim 19, wherein
the amount of plasticizers in wt % in the cable sheathing after at least 2000 h is still at least 60% of the original amount in the cable sheathing, measured under the conditions of LV 312.

21. A method for jacketing elongate material, which comprises jacketing said elongate material with the adhesive tape of claim 14, where the adhesive tape is passed in a helical line around the elongate material or alternatively where the elongate material is wrapped in axial direction by the tape.

22. A cable loom, jacketed with an adhesive tape of claim 14.

23. A method for producing the adhesive tape of claim 14 from a textile carrier and a pressure-sensitive adhesive applied on at least one side of the carrier, which comprises
applying the pressure-sensitive adhesive to at least one side of the textile carrier, and
optionally drying the pressure-sensitive adhesive.

24. The method as claimed in claim 23, characterized in that wherein the pressure-sensitive adhesive comprises an aqueous acrylate dispersion which is prepared by the process of emulsion polymerization.
